(19) United States
(12) Patent Application Publication
(10) Pub. No.: US 2026/0111275 A1
(43) Pub. Date: Apr. 23, 2026

(54) ASYNCHRONOUS CALL MANAGEMENT FOR A DISTRIBUTED MULTI-AGENT SYSTEM

(71) Applicant: Microsoft Technology Licensing, LLC, Redmond, WA (US)

(72) Inventors: Prasanna Narayanasamy, Sunnyvale, CA (US); Tyler C. Grant, San Carlos, CA (US); Karthik Ramgopal, Atherton, CA (US)

(21) Appl. No.: 19/043,334

(22) Filed: Jan. 31, 2025

Related U.S. Application Data
(60) Provisional application No. 63/709,936, filed on Oct. 21, 2024.

(51) Int. Cl. G06F 9/50

(52) U.S. Cl. CPC G06F 9/5027

(57) ABSTRACT

An example provides a multi-agent system. At a managing agent, a first lookup of the registry determines a task agent to perform a task. A task invocation is sent to the task agent. The task invocation is to cause the task agent to initiate the task. A skill is received from the task agent. A second lookup of the registry is to determine whether to maintain a thread when invoking a skill agent to perform the skill. Responsive to determining that a thread is not to be maintained to invoke the skill agent to perform the skill, the task agent is identified in a call to the skill agent. The call is to invoke the skill agent to perform the skill asynchronously to the task initiated by the task agent. Via the managing agent, the task agent is to provide a response to the task to a device.

### CROSS-REFERENCE TO RELATED APPLICATION

This application claims the benefit of and priority to U.S. Provisional Patent Application No. 63/709,936, filed Oct. 21, 2024, which is incorporate herein by this reference in its entirety.

### TECHNICAL FIELD

Technical fields to which this disclosure relates include multi-agent systems. Other technical fields to which this disclosure relates include applications of large language model (LLM)-based agents using distributed systems.

### COPYRIGHT NOTICE

This patent document, including the accompanying drawings, contains material that is subject to copyright protection. The copyright owner has no objection to the facsimile reproduction of this patent document, as it appears in the publicly accessible records of the United States Patent and Trademark Office, consistent with the fair use principles of the United States copyright laws, but otherwise reserves all copyright rights whatsoever.

### BACKGROUND

Automated agents include hardware and/or software components that are capable of performing user-level tasks and actions without or with minimal direct human instruction. Agents differ from daemons and other computer programs that run as background processes in the level of complexity of the tasks they execute and the degree to which the agents are capable of interacting with human users.

A device or system may include one or more autonomous and/or semi-autonomous agents. For example, some vehicles include an autonomous agent that controls the vehicle in response to sensor signals, without asking a human operator to, e.g., step on the brake or turn the steering wheel. A semi-autonomous agent of the vehicle may automatically load a map with a navigation plan to get the human driver to a destination but then wait for the human driver to confirm the plan and start the vehicle before starting down the road.

A distributed system is a computing system that includes multiple different components that reside on different machines. The different machines are sometimes located in different geographic locations. The components of the distributed system communicate with each other by passing messages over a network.

### BRIEF DESCRIPTION OF THE DRAWINGS

The disclosure will be understood more fully from the detailed description given below and from the accompanying drawings of various examples of the disclosure. The drawings are for explanation and understanding only and should not be taken to limit the disclosure to the specific examples shown.

FIG. 1 is a block diagram of a distributed multi-agent system in accordance with some examples of the present disclosure.

FIG. 2 is a component-based flow diagram of an example method for managing communications between agents of a multi-agent system in accordance with some examples of the present disclosure.

FIG. 3 is a component-based flow diagram of an example method for managing communications between agents of a multi-agent system in accordance with some examples of the present disclosure.

FIG. 4 is a component-based flow diagram of an example method for managing communications between agents of a multi-agent system in accordance with some examples of the present disclosure.

FIG. 5 is a component-based flow diagram of an example method for managing communications between agents of a multi-agent system in accordance with some examples of the present disclosure.

FIG. 6 is a diagram of an example schema for a registry in accordance with some examples of the present disclosure.

FIG. 7 is a flow diagram of an example method for managing communications among agents of a multi-agent system in accordance with some examples of the present disclosure.

FIG. 8 is a component-based flow diagram of an example method for creating and configuring an agent using components of an agent system in accordance with some examples of the present disclosure.

FIG. 9 is a block diagram of a computing system that includes an agent system in accordance with some examples of the present disclosure.

FIG. 10 is a block diagram of an example computer system including components of an agent system in accordance with some examples of the present disclosure.

### DETAILED DESCRIPTION

Generative machine learning models (GMLMs), such as large language models (LLMs), have demonstrated the ability to perform relatively simple tasks (e.g., single-step tasks or tasks that do not include any sub-tasks) using a conversational natural language question and answer format. However, incorporating LLMs into systems of autonomous and/or semi-autonomous agents to perform more complex tasks (e.g., multi-step tasks or tasks that have one or more sub-tasks) is much more technically challenging for multiple reasons.

One reason is that on initiation of a task, an LLM's workload is typically completed at the same machine or data center at which it was initiated. Another reason is that LLMs are often used to perform complex reasoning tasks that can take much longer to execute than simpler tasks like database queries and embedding lookups. These aspects make it challenging to scale LLM-based agents to large, distributed, online systems such as content distribution systems, which often have millions or hundreds of millions of users distributed across many different user devices that connect to the online system via multiple different data centers.

Additionally, online systems with large user bases often implement traffic shifting and load balancing policies to ensure that network traffic is handled in optimal ways, e.g., by routing users to data centers based on geographic proximity or shifting traffic to different data centers as user locations change. These traffic shifting and load balancing policies are not exposed to the LLMs because the LLMs are typically engaged after the traffic routing decisions have been made. Further, these policies are not always fully accessible to all of the different communication methods, agents, or types of calls that need to be made in a large-scale multi-agent system. Thus, it is a technical challenge to ensure reliability of asynchronous communications in this context.

Various examples described herein seek to mitigate these and/or other technical challenges by providing reliable asynchronous communication frameworks and patterns that are capable of serving as a foundation for distributed multi-agent systems that include GMLM-based agents. As described in more detail below, examples facilitate the implementation of distributed agent networks that are capable of handling large computational workloads, such as complex tasks performed by GMLMs, alone or in combination with smaller workloads, such as simpler tasks that do not require a GMLM. Asynchronous communication frameworks and patterns as described are capable of distributing agent-based tasks across multiple data centers in a reliable manner. Various examples are capable of shifting work from one data center to a different data center in accordance with applicable policies, performance metrics, or other criteria.

In some examples, a multi-agent system includes a managing agent, task agents, and skills agents. Agent often refers to a semi-autonomous or autonomous software system that is able to consume information and/or signals from its environment, execute logic, reasoning, and learning processes, and perform actions to achieve a specific goal or set of goals with minimal human guidance or intervention. In some examples, agents have multiple levels of autonomy. Some agents have the capacity to perform tasks requiring complex understanding, reasoning, learning, and adaptability. Some agents are capable of processing and interpreting natural language and/or multimodal digital content, determining relevant context, formulating plans, and learning from interactions or data inputs. Some agents dynamically adapt their processing capabilities in response to changing environments or goals. Some agents are capable of interacting with human users and other system components, including other agents or groups of agents. Unlike simpler automated systems, agents are data-driven and are capable of utilizing machine learning and/or deep learning techniques to improve their performance over time, making them suitable for a wide range of applications including digital assistance, personalized learning, and sophisticated problem-solving scenarios.

An agent is capable of interfacing with a messaging platform to receive messages on threads and send replies to received messages. The messaging platform supports user-to-agent and agent-to-agent message-based communications. The messaging platform is capable of providing delivery verifications across data centers and confirmations that calls to software components such as functions and plugins have been made.

Some agents are capable of invoking one or more other agents. In some examples, a managing agent is capable of invoking one or more task agents and/or one or more skills agents. A managing agent invokes skill agents in response to signals from task agents, such that task agents do not directly invoke skill agents, in some examples.

A task is an action, process, function, operation, or group or series of operations that is capable of being performed autonomously or semi-autonomously by one or more agents. A task often corresponds to a request, such as an input received from a client device, network, sensor, robot component, or autonomous vehicle component. Illustrative nonlimiting examples of tasks include executing queries, generating content, and generating computer code such as instructions to control a display at a client device, instructions to control a robotic or autonomous vehicle component, instructions to control the routing of traffic on a network, or instructions to distribute tasks across multiple data centers. A task often includes more than one skill, e.g., an ordered sequence of skills, such that results of execution of the skills included in the task collectively produce the output of the task; e.g., the output of a skill is used as the input to another skill. A task is sometimes defined as a specialized type of skill, such as a skill that includes one or more calls to a GMLM, or a skill that cannot be invoked by a simple, well-defined remote function call.

A skill is a function that is performed autonomously or semi-autonomously by a skill agent. A skill agent is essentially a remote function call, also referred to as a remote procedure call, that is well-defined with both structured input and structured output (e.g., the call has defined input parameters and output parameters). In some examples, a skill agent is capable of invoking another agent, e.g., by sending a message to the other agent on a thread via the messaging platform. In some examples, a skill agent is capable of invoking another skill, e.g., by making a remote function call to that other skill. Illustrative nonlimiting examples of skills include function calls that perform one or more sub-tasks of a task, such as query pre-processing, processing input, or obtaining parameters to control a display at a client device or a robotic or autonomous vehicle component, or to control the routing of traffic on a network, or to distribute tasks across multiple data centers.

In some examples, the managing agent uses the messaging platform to invoke task agents and uses remote function calls to invoke skills agents. In some examples, the managing agent uses a combination of the messaging platform and remote function calls to ensure reliability of asynchronous skills.

An agent can be assigned different roles in different execution contexts. In some examples, an agent functions as a managing agent with respect to a particular task or skill while also functioning as a task agent or a skill agent with respect to different tasks or skills.

The managing agent distributes work among the task agents and skills agents via asynchronous communication services that include a distributed messaging platform and a remote procedure call framework. The managing agent initiates and maintains asynchronous communications with task agents and skills agents to ensure the completion of all skills required to be performed for a given task.

In some examples, when the managing agent invokes a task agent, the managing agent maintains agent-specific information for the invoked task agent. When the managing agent invokes a skill agent on behalf of the task agent, the managing agent includes the agent-specific information in the call to the skill agent. This type of call enables subsequent asynchronous communications returning from the skill agent to reference the task agent using the agent-specific callback/endpoint information. Using the agent-specific reference to the task agent, the managing agent is able to update the respective task agent when the skill agent has finished executing the skill. Using these and/or other techniques described, the managing agent is capable of distributing work among other agents in a manner that enables long running workloads, such as GMLM-based tasks, to be performed asynchronously with other tasks.

Information about the capabilities, call types, and execution requirements of the task agents and skills agents are registered and maintained in a centralized registry. The centralized registry is accessible to the managing agent. In some examples, access to the registry is granted only to the registry such that task agents and skill agents cannot directly access the registry. In other examples, the registry is accessible to other agents, such as task agents, e.g., to enable task agents to determine skills needed to perform a particular task. In response to a task, the managing agent uses the registry to select a task agent for the execution of the task.

The disclosure will be understood more fully from the detailed description given below, which references the accompanying drawings. The detailed description of the drawings is for explanation and understanding, and should not be taken to limit the disclosure to the specific examples described. In some examples, components with the same name but different reference numbers in different figures have the same or similar functionality such that a description of one of those components with respect to one figure is applicable to other components with the same name in other drawings. Also, in the drawings and the following description, components shown and described in connection with some examples are capable of being used with or incorporated into other examples. In some examples, a component illustrated in a certain drawing is not limited to use in connection with the example to which the drawing pertains, but is usable with or incorporated into other examples, including examples shown in other drawings.

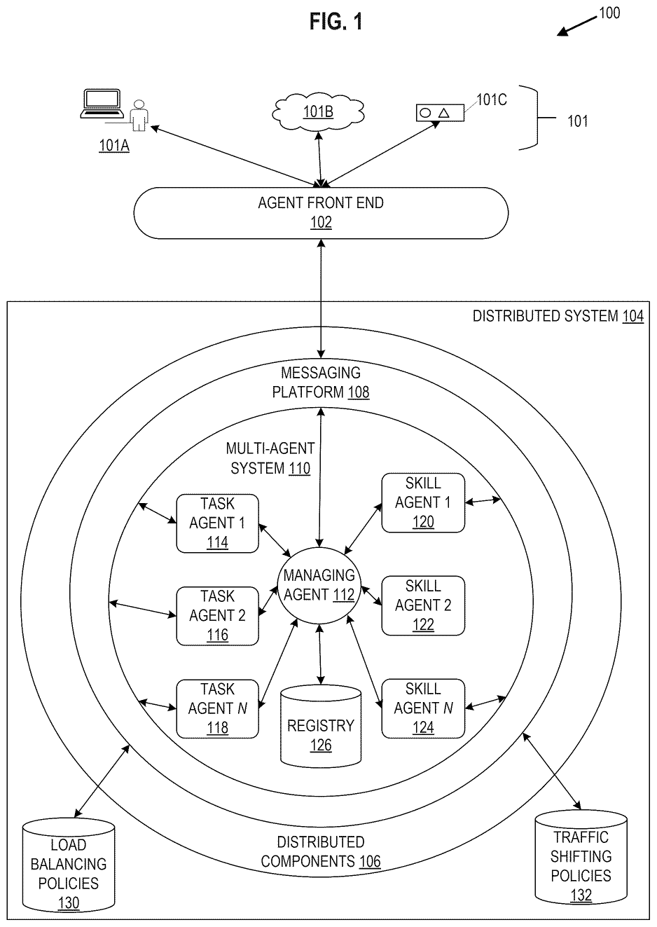

FIG. 1 is a block diagram of a distributed multi-agent system in accordance with some examples of the present disclosure.

In FIG. 1, a computing system 100 includes an environment 101, an agent front end 102, and a distributed system 104. The distributed system 104 interacts with the environment 101 via the application front end 102. The environment 101 includes one or more user devices 101A, a network 101B, and/or one or more sensing devices 101C. A non-exhaustive list of examples of user devices 101A includes computing devices, such as laptop computers, smart phones, mobile computing devices, smart appliances, wearable devices, game controls, vehicle controls, robotic devices, etc. A non-exhaustive list of examples of networks 101B includes wireless, optical, and/or wired communication networks. A non-exhaustive list of examples of sensing devices 101C includes motion sensors, load cells, force sensors, light sensors, temperature sensors, physiological sensors, energy sensors, and network sensors.

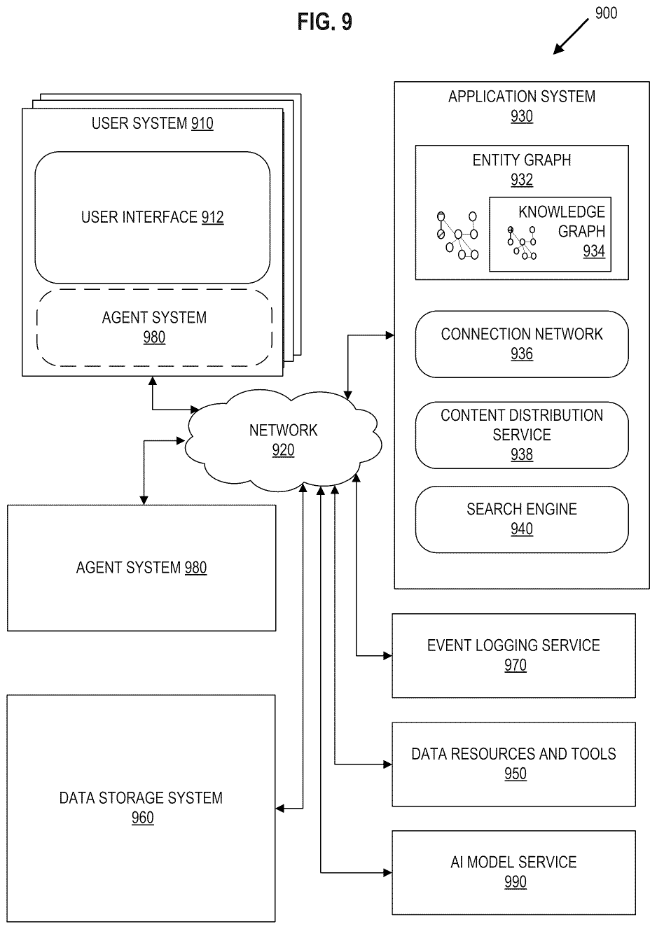

The agent front end 102 includes an application layer, presentation layer, user interface (UI) layer, and/or data layer of an agent-based task-oriented application system, e.g., an application system 930 described with reference to FIG. 9 or another type of online system. The agent front end 102 manages and facilitates electronic, electromagnetic, optical, and/or other types of signal-based communications between the environment 101 and the distributed system 104.

Responsive to receiving input via one or more components of the environment 101, the agent front end 102 provides portions of the input to distributed system 104 and provides portions of output produced by distributed system 104 to one or more components of the environment 101. A non-exhaustive list of examples of output includes digital data such as structured and/or unstructured text, multimodal content, and/or instructions such as control signals.

The distributed system 104 includes a multi-agent system 110. The multi-agent system 110 is supported by a messaging platform 108. The multi-agent system 110 and the messaging platform 108 are distributed across distributed components 106 of the distributed system 104.

The messaging platform 108 includes messaging capabilities that organize groups of related messages into threads, where each message has an associated sender, one or more recipients, and time stamp. The messaging platform 108 enables users and/or other components of the environment 101 to directly send messages to and receive messages from one or more agents of the multi-agent system 110. The messaging platform 108 also enables agents of the multi-agent system 110 to directly or indirectly send messages to and receive messages from one or more other agents of the multi-agent system 110. In some examples, a managing agent 112 of the multi-agent system 110 manages all communications with, between, or among, other agents of the multi-agent system 110 such that agents do not communicate directly with other agents or components of the environment 101 except via the managing agent 112.

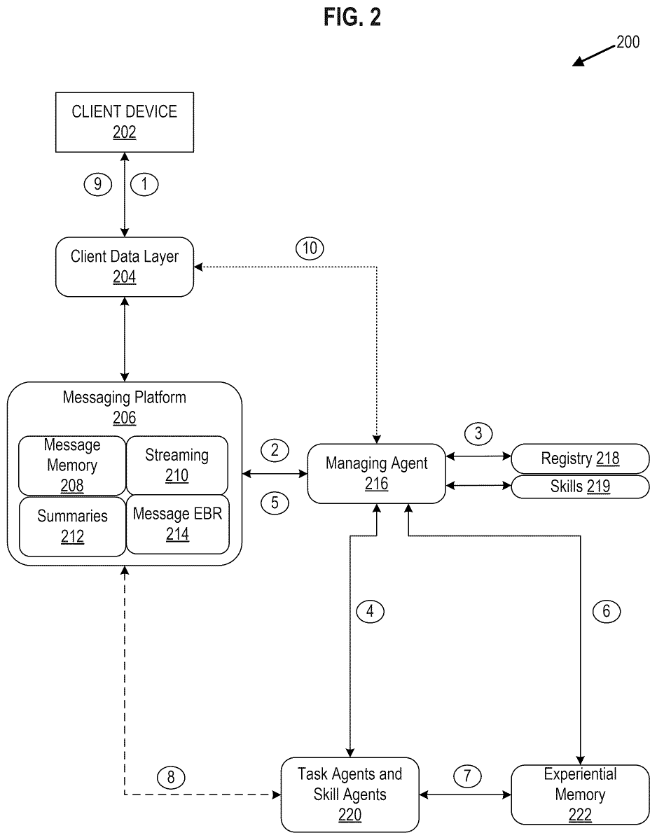

The messaging platform 108 enables asynchronous messaging between or among components of the environment, agents, and other agents. The messaging platform 108 uses threads to keep track of message histories between or among agents and/or components of the environment 101. In some examples, the messaging platform 108 creates a separate message queue or mailbox for each entity (e.g., each user and agent) that sends and receives messages via the messaging platform 108. An example of a messaging platform 108 is described in more detail with reference to messaging platform 206 of FIG. 2.

A non-exhaustive list of examples of distributed components 106 includes devices, machines, servers, server clusters, data centers, distributed data stores, and distributed caches. In some examples, various distributed components 106 are located in various different geographic locations. Some portions of messaging platform 108 and/or some portions of multi-agent system 110 are located on different distributed components 106, including some distributed components 106 that are located in different geographic locations.

The multi-agent system 110 receives inputs, e.g., requests, signals, or queries, from the messaging platform 108. The multi-agent system 110 executes tasks in response to received inputs using agents, and provides output to the agent front end 102 via messaging platform 108 in response to the associated inputs. In some examples, the output produced by the multi-agent system 110 includes digital content for presentation via a graphical or multimodal user interface at one or more user devices 101A. A non-exhaustive list of examples of output includes search results, conversational natural language responses to questions, recommendations, access control instructions, user interface elements; control signals for processing by one or more components of the network 101B, such as network traffic routing instructions, load balancing instructions, network security instructions; control signals for processing by one or more components of the sensing devices 101C, such as navigation instructions for a robotic device or vehicle, articulation or manipulation instructions for a component of a robotic device or vehicle, or operational instructions for a robotic device or vehicle, such as instructions to start, stop, or temporarily suspend the deployment of a component of the device or vehicle.

The multi-agent system 110 includes a managing agent 112, N task agents 114, 116, 118, N skill agents 120, 122, 124, and a registry 126. In the illustrated examples, N is any positive integer such that the number of task agents and/or skill agents is capable of being less than three or greater than or equal to three. Also, the value of N is variable for different instances of N; e.g., the number N of task agents is different than the number N of skill agents in some examples.

The managing agent 112 provides an orchestration layer that coordinates all of the message passing and calls involving task agents 114, 116, 118 and skill agents 120, 122, 124. A task agent 114, 116, 118 is an agent that is capable of autonomously or semi-autonomously executing a task. A skill agent 120, 122, 124 is an agent that is capable of autonomously or semi-autonomously executing a skill. In different contexts, e.g., responsive to different inputs from the environment 101, managing agent 112 performs the role of a task agent or a skill agent, or a task agent 114, 116, 118 performs the role of managing agent 112 or a skill agent, or a skill agent 120, 122, 124 performs the role of managing agent 112 or a task agent. Thus, the configuration of managing agent 112, task agents 114, 116, 118, and skill agents 120, 122, 124 is variable depending on the particular inputs received or task to be performed.

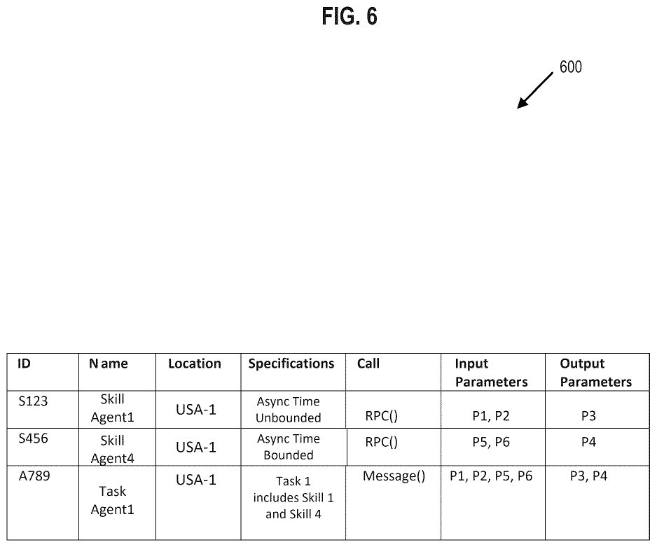

The managing agent 112, task agents 114, 116, 118 and skill agents 120, 122, 124 are registered in registry 126. Registry 126 is a searchable data store that includes a data record for each agent, including managing agent 112, each task agent 114, 116, 118, and each skill agent 120, 122, 124 included in the multi-agent system 110. In the registry 126, the data record for an agent of multi-agent system 110 specifies a method of communicating with the agent, e.g., whether the agent is to be communicated asynchronously or synchronously, whether the messaging platform 108 or a remote function call is to be used to invoke and communicate with the agent, and associated parameters. An example of a registry 126 is described with reference to registry 600 of FIG. 6. In some examples, the registry 126 is distributed. Although the registry is shown as a single entity in FIG. 1, examples of the registry 126 are part of distributed components 106 or distributed over many network nodes of a distributed system.

The distributed system 104 includes one or more data stores that store and maintain load balancing policies 130 and traffic shifting policies 132. Load balancing policies 130 include rules or logic that the distributed system 104 uses to distribute work among the distributed components 106 in accordance with network traffic patterns, capabilities and capacities of the distributed components, and/or other criteria. Traffic shifting polices 132 include rules or logic that the distributed system 104 uses to shift network traffic from one of the distributed components 106 to another of the distributed components 106 responsive to specific triggers, conditions, or criteria. In some examples, load balancing policies 130 are applicable to network traffic in the aggregate while traffic shifting policies 132 are applicable to traffic associated with individual components of the environment 101.

In some examples, a load balancing policy 130 causes the distributed system 104 to assign tasks requested by users to the distributed components 106 that are geographically closest to the user devices 101A at the time of the requests. In some examples, a traffic shifting policy 132 causes the distributed system 104 to shift network traffic associated with a particular user's request to a different distributed component 106 at a different time subsequent to the time of the request, e.g., responsive to detecting that the user's device has moved to a different geographic location.

The load balancing policies 130 and the traffic shifting policies 132 are accessible to the messaging platform 108, enabling the multi-agent system 110 to determine the load balancing policies 130 and/or traffic shifting policies 132 that are implicated by a given task.

In operation, a component of the environment 101, e.g., a user of a user device 101A, sends a request containing one or more inputs to the agent front end 102. The agent front end 102 interacts with the messaging platform 108. The messaging platform 108 invokes the managing agent 112 and sends a message containing the request to the managing agent 112.

The managing agent 112 uses the registry 126 to determine a task agent 114, 116, 118 to handle the request. The managing agent 112 sends a message including the request to the selected task agent via the messaging platform 108. The messaging platform 108 notifies the task agent that it has received a message that is addressed to the task agent. The task agent receives the message including the request and processes the request. The task agent sends a response to the managing agent 112. The managing agent 112 interprets the response from the task agent, e.g., by assigning a status label to the response such as done, incomplete, failure, or another type of status label.

The managing agent 112 ensures that the task agent completes the assigned task. In some examples, the managing agent 112 resends the request to the task agent iteratively until the status returned by the task agent indicates that the task is complete.

In processing the request, the task agent determines one or more skills that need to be performed to complete the task. In some examples, the task agent uses the registry 126 to select the one or more skills to perform the task. In other examples, the skill or skills included in the task are defined within the programmable code of the task agent itself. In still other examples described in more detail below, all communications with the registry 126 are managed by the managing agent 112 such that the task agent only obtains information from the registry 126 indirectly via the managing agent 112.

In some examples, to select a skill from the registry 126 on behalf of a task agent, the managing agent 112 requests or simply receives a skill identifier (ID) from the task agent. The managing agent 112 uses the skill ID to look up the corresponding skill agent in the registry 126. In other examples, the registry 126 is capable of being queried without a skill ID, e.g., even if the skill ID is not known, such as by using natural language input or one or more parameters other than a skill ID. The managing agent 112 obtains the details needed to make the call to the skill agent from the registry 126 and initiates the call.

Depending upon the skill definition contained in the registry 126, the corresponding skill agent of a selected skill is invoked synchronously or asynchronously. In some examples, the managing agent 112 performs the skill invocation irrespective of whether the skill invocation is synchronous or asynchronous. In other examples, the task agent invokes the skill agent directly rather than indirectly via the managing agent 112.

If the managing agent 112 asynchronously invokes a skill agent, this enables the task agent to perform other portions of the task, such as invoking other skills, in parallel with the skill executed by the already-invoked skill agent. In this case, the managing agent 112 keeps track of the skill invocation and receives a response from the skill agent when the skill has finished executing. When the managing agent 112 receives the response from the skill agent, the managing agent 112 sends a message to the task agent indicating that the skill has finished executing. In some examples, the message back to the task agent is formulated as a callback on a specific resource, e.g., an applicant programming interface (API) such as a representational state transfer (REST) or remote procedure call (RPC) API call.

In some examples, applicable load balancing policies 130 and/or traffic shifting policies 132 are set at the level of the distributed system 104 as a whole and not at the agent level. As a result, the policies 130, 132 are applied to inputs received from components of the environment 101 via the agent front end 102 but those policies are not exposed to inter-agent communications. In these cases, since the agents of the multi-agent system 110 are not exposed to the policies 130, 132, the managing agent 112 ensures that the policies are maintained at the agent level.

In some examples, when a task is received from a component of the environment 101 via the agent front end 102, the messaging platform 108 includes the location of the distributed component 106 assigned to the requesting component in a message to the managing agent 112. In some examples, the managing agent 112 uses the registry 126 to look up location information for available task agents. In other examples, another component of the multi-agent system 110, such as an orchestration agent, determines the location of the distributed component 106, such that the processing need to determine how to call a task agent does not need to be performed by the managing agent 112. The managing agent 112 selects a task agent that is located at the distributed component 106 that has been assigned to the component of the environment 101 that requested the task, in accordance with the policies 130, 132. In some examples, the managing agent 112 includes the location of the task agent in calls to the skill agents involved in performing portions of the task, to ensure that the policies 130, 132 are maintained with respect to the invocations of the associated skills. In other examples, the managing agent is not required to know the location of the agent that it is calling, e.g., the location of the task agent is not required to be included in calls by the managing agent to the skill agents.

In some examples, the managing agent 112 ensures that all skills associated with a given task are assigned to the same distributed component 106, e.g., the same data center, to ensure that a policy of avoiding duplicate work is maintained. This is beneficial because, in a distributed system, computing resources are often replicated at each location, creating the possibility of duplication of work by different data centers.

In some examples, a traffic shifting policy causes traffic from a particular component of the environment 101 to be shifted from one distributed component 106 to another distributed component 106 after expiration of a defined time interval. In this case, the managing agent 112 ensures that all work associated with that component of the environment 101 is shifted to the subsequent distributed component 106 so that the traffic shifting policy is maintained through the task execution. For instance, if a traffic shifting policy shifts a user from one data center to a new data center, the managing agent 112 structures agent calls so that the agent work associated with the user's request follows the user to the new data center. Thus, the managing agent 112 is able to ensure that applicable policies 130, 132 are observed by the agents of the multi-agent system 110 even if those agents are not directly exposed to those policies.

In some examples, the distributed system 104 includes an orchestration layer that performs some of the functions described above in connection with the managing agent 112. In those examples, the orchestration layer provides an interface between the messaging platform 108 and the multi-agent system 110. The orchestration layer includes a service that receives messages from the messaging platform 108 and calls agents in response to those messages, via synchronous or asynchronous calls as the case may be. In some examples, the traffic shifting and load balancing policies are handled by the orchestration layer rather than the managing agent 112.

In some examples, the orchestration layer is a standardized service that does not use a GMLM to perform its services. In those examples, the managing agent 112 determines which agent to call based on business logic and/or output of a GMLM. In some examples, the managing agent 112 interfaces with the environment 101, determines the task to be performed based on the signal(s) from the environment 101, and distributes the task to other agents via messages that are sent from the managing agent to the other agents, e.g., the task agents and/or skill agents.

The examples shown in FIG. 1 and the accompanying description are provided for illustration purposes. This disclosure is not limited to the described examples.

FIG. 2 is a component-based flow diagram of an example method for managing communications between agents of a multi-agent system in accordance with some examples of the present disclosure.

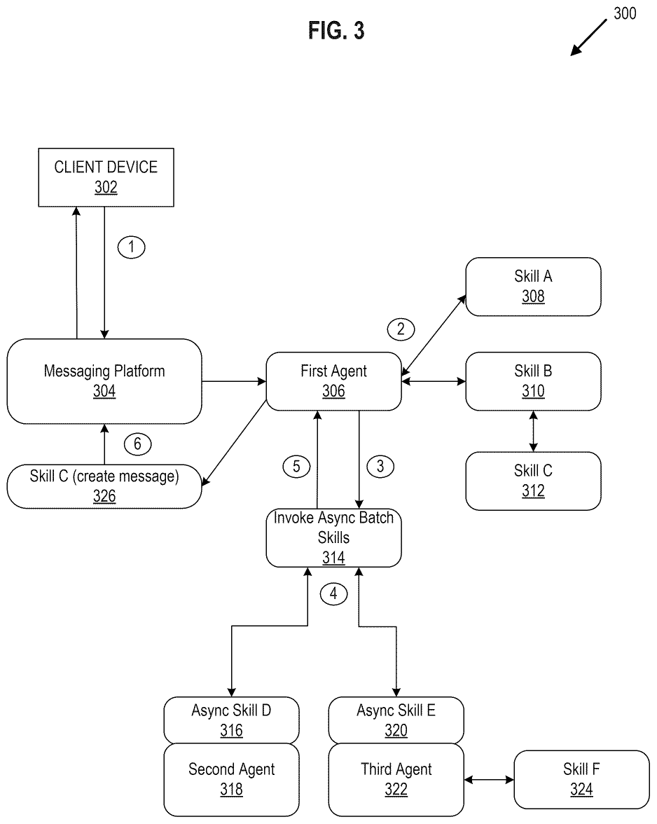

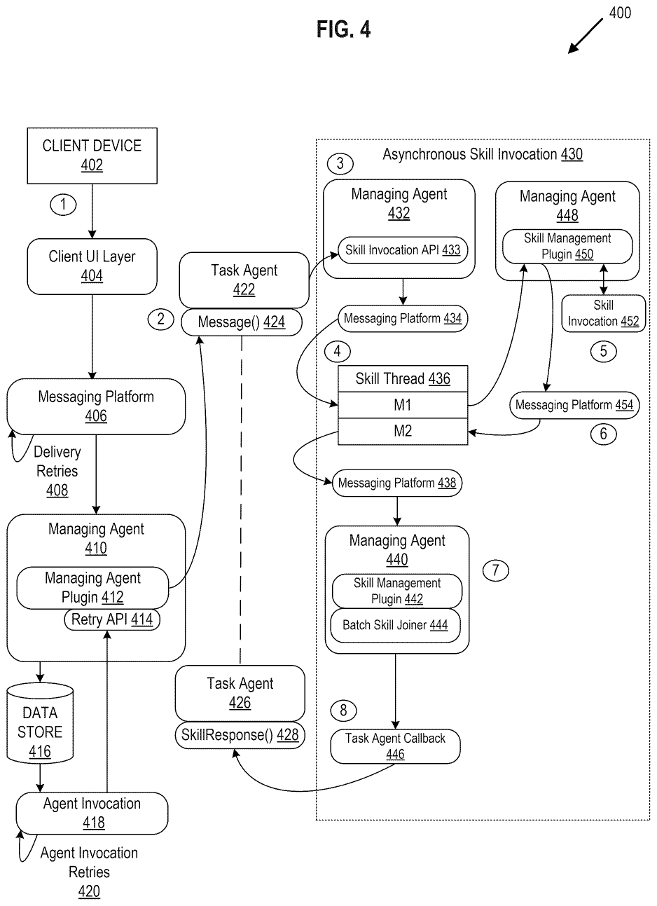

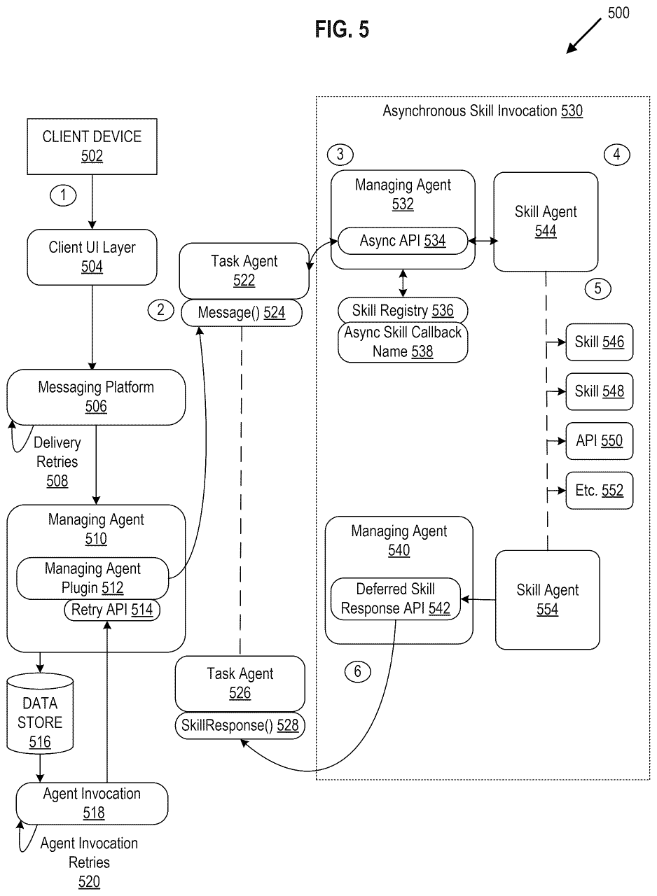

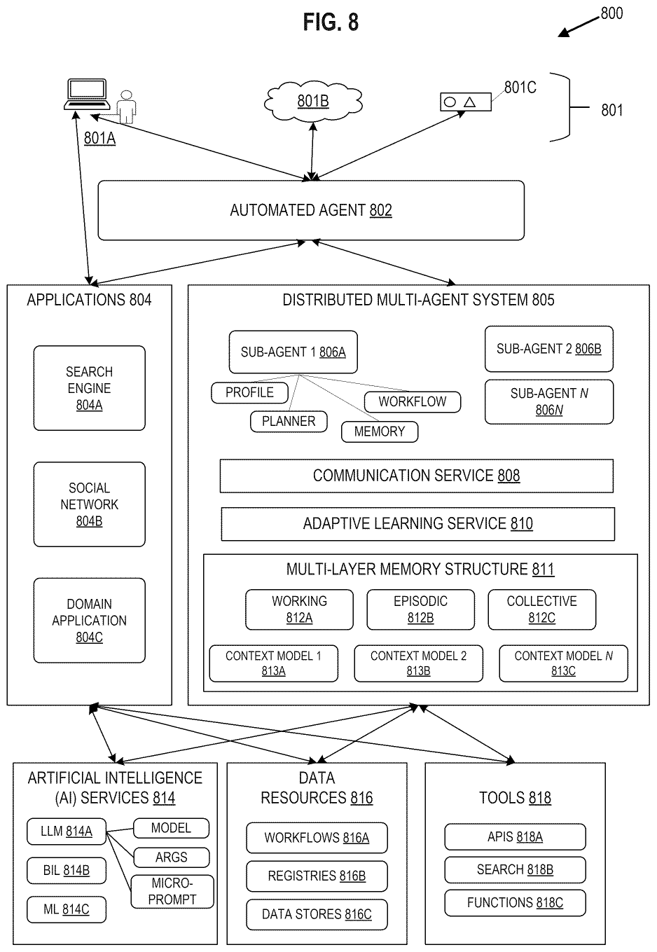

The method 200 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 200 is performed by the computing system components shown in FIG. 1, FIG. 2, FIG. 3, FIG. 4, FIG. 5, FIG. 6, one or more components of computing system 800 of FIG. 8, or agent system 980 of FIG. 9. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

FIG. 2 illustrates interconnections between various components of a multi-agent system. In the example of FIG. 2, a user of a client device 202 initiates a request and the request is received by a client data layer 204, at flow 1. If the request is for the multi-agent system to perform a task for a user, the client data layer 204 sends the request to a managing agent 216 via a messaging platform 206. If the request is to test or observe operations of the multi-agent system, the client data layer 204 sends the request directly to the managing agent 216, at flow 10. In some examples, flow 1 occurs if the originator of the request is a typical user of the multi-agent system while flow 10 occurs if the originator is a user with special privileges, such as a developer or administrator.

The messaging platform 206 includes message memory 208, an event streaming service 210, summaries service 212, and a message EBR (embedding based retrieval) service 214. The message memory 208 stores messages and message threads, including user-agent and agent-agent transaction histories. The event streaming service 210 logs, processes and stores event data associated with messages sent and received via the messaging platform 206. The event streaming service 210 supports distributed stream processing and provides a high-throughput, low-latency, fault-tolerant platform for handling real-time data feeds and ensuring that messages are delivered and responded to. The event streaming service 210 interacts with the message memory 208 and enables agents to quickly edit messages that have already been sent, such that the results of those edits is a stream of message edits that are capable of being sent out via a low-latency platform. Low-latency refers to a time interval in which a response to an input is provided, where the size of the time interval is variable in accordance with the requirements of a particular design or implementation. In some examples, the event streaming service 210 enables real-time updates to information presented to users. The summaries service 212 provides an augmentation of the message memory 208, which enables the asynchronous generation of a summary of messages in a particular message thread. In some examples, the summaries service 212 uses a GMLM to generate summaries of message histories stored in message memory 208.

The message EBR service 214 provides matching, scoring, and/or classification services that are implemented using embeddings. Embedding refers to a machine learning model-generated numerical representation of an input to the machine learning model. An embedding encodes information input to the machine learning model, e.g., a set of features associated with an entity and/or attribute, relative to an embedding space, where the embedding space represents a set of training data with which the machine learning model has been trained. An embedding is capable of being expressed as a vector, where each dimension of the vector includes a numerical value that is an integer or a real number (e.g., a floating-point number). The numerical value assigned to a given dimension of the vector conveys information about the data represented by the embedding, relative to the embedding space.

In some examples, message EBR service 214 is used to match requests received via the client data layer 204 to tasks that are capable of being performed by agents of the multi-agent system. In some examples, message EBR service 214 includes one or more content filters such as spam filters, which are applied to client requests before the requests are assigned to agents and/or to agent outputs before the outputs are provided to the client device 202.

The messaging platform 206 operates across distributed components, e.g., across multiple data centers of a distributed computing system. The messaging platform 206 extends load balancing and/or traffic shifting policies, which are typically defined at the top level of the distributed computing system (e.g., across data centers), to agents of the multi-agent system. In some examples, the messaging platform 206 ensures data consistency of messages and threads across data centers. Storage in the messaging platform 206 provides data replication services based on access levels. Some data is replicated so that it is accessible at any location in the distributed system without time restrictions. Other data is replicated with access limitations such as per-user or per-agent partitioning schemes which enable data stored on the messaging platform 206 for a particular user or agent to be routed to a particular location (e.g., a specific data center) for a predetermined period of time.

The messaging platform 206 is agnostic as to the sources and recipients of messages. The messaging platform 206 processes, routes, and logs messaging activities the same way irrespective of whether the messages are sent or received by users or agents, and also without regard for specific roles that are assigned to particular users or agents.

The messaging platform 206 notifies a managing agent 216 that a new message has arrived, at flow 2. An example of managing agent 216 is described with reference to managing agent 112 of FIG. 1. The managing agent 216 reads the message, obtains context data as needed, and queries registry 218, at flow 3. The managing agent 216 uses the registry 218 to identify and invoke skills 219. The managing agent 216 invokes skills at the request of task and/or skill agents 220.

To obtain context data, the managing agent 216 queries message memory 208 and/or summaries service 212, in some examples. An example of registry 218 is described with reference to registry 126 of FIG. 1.

The managing agent 216 uses registry 218 to select one or more task agents and/or skill agents that will individually or collectively generate a response to the task. At flow 3, the managing agent 216 obtains the information it needs to invoke the selected task agents and/or skill agents, e.g., call information for skills 219, such as remote function calls and/or API calls, using the messaging platform 206.

The managing agent 216 invokes the selected task agents and/or skill agents 220, at flow 4, using the call information obtained from registry 218. Some skills are invoked synchronously while other skills are invoked asynchronously, depending on the skill and/or associated context. The skill invocation pattern provides a structured call and response using a structured data interchange format, e.g., JavaScript Object Notation (JSON) format. The invoked skill will either reply synchronously in the response or asynchronously with a callback.

In some examples, task agents or skill agents can invoke other skills, resulting in a tree of work that fans out from the initial call from the managing agent 216. The skills that are invoked asynchronously send a reply to the managing agent 216 using, e.g., a callback. The skills that are invoked synchronously reply synchronously in the response. In some examples, after invoking the selected task agents and/or skill agents 220, the managing agent 216 uses the messaging platform 206 to monitor and ensure that execution of invoked skills finishes, at flow 5. When synchronous and/or asynchronous replies are received from all of the invoked skills, the managing agent 216 replies to the client device 202 via the messaging platform 206 and client data layer 204, at flow 5.

To perform requested tasks and skills, the task agents and skill agents 220 access the message memory 208 to obtain a history of user requests and context. Some task agents and/or skill agents use the message memory 208 to generate messages; e.g., context stored in the message memory 208 is used by agents as input to a GMLM to cause the GMLM to generate and output message content.

At flow 6, the managing agent 216 uses experiential memory 222 to track message processing states across distributed components, e.g., across data centers. At flow 7, the task agents and skill agents 220 use the experiential memory 222 to store information obtained by the respective agent during execution of the respective task or skill.

The experiential memory 222 stores information about the current state of each task or skill. The experiential memory 222 enables state tracking and storage of information about messages, e.g., the status of whether a message is processed, in a reliable way that can be replicated across data centers or other distributed components of the distributed system so that the data written to experiential memory 222 is available after a traffic switch occurs. A traffic switch is where traffic is rerouted from the messaging platform 206 to another data center or other component of the distributed system. In some examples, experiential memory 222 includes a lightweight data store that requires minimal schema storage or schemaless storage.

The examples shown in FIG. 2 and the accompanying description are provided for illustration purposes. This disclosure is not limited to the described examples.

FIG. 3 is a component-based flow diagram of an example method for managing communications between agents of a multi-agent system in accordance with some examples of the present disclosure.

The method 300 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 300 is performed by the computing system components shown in FIG. 1, FIG. 2, FIG. 3, FIG. 4, FIG. 5, FIG. 6, one or more components of computing system 800 of FIG. 8, or agent system 980 of FIG. 9 . . . . Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

FIG. 3 illustrates interconnections between various components of a multi-agent system, including an example of a batch invocation of asynchronous skills in combination with invocations of synchronous skills. In the example of FIG. 3, a user of a client device 302 initiates a request and the request is received by a messaging platform 304, at flow 1. The messaging platform 304 sends a message containing the request to a first agent 306. The first agent assumes the role of the managing agent in the illustrated example. In other examples, any agent is capable of invoking skills.

The first agent 306 invokes each of skill A 308 and skill B 310 synchronously, at flow 2. Skill B invokes skill C 312. Skill A 308 replies synchronously to the first agent 306 with its response. Skill B receives a reply from skill C 312 and replies synchronously to the first agent 306 with its response including the results of skill C 312.

At flow 3, the first agent 306 invokes multiple skills, e.g., skill D 316 and skill E 320 asynchronously in a batch. In some examples, an orchestration layer calls the skills in parallel, waits for the responses, and sends the responses back to the invoking agent, e.g., the first agent 306 . . . . Use of the orchestration layer enables agents to invoke skills simply by the skill name or skill ID because the orchestration layer handles the calling of the skills.

In other examples, the second agent 318 and third agent 322 are invoked via direct messaging, e.g., via an orchestration layer and/or managing agent, in parallel with callbacks so that the results of async skill D 316 and async skill E 320 are capable of being returned to the first agent 306 in the same call, at flow 4. At flow 5, the callback provided by the first agent 306 on the initial invocation is used by the agents 318, 322 to reply to the first agent 306. The first agent 306 invokes skill C 326 to create a reply message for delivery to the client device 302. The first agent 306 sends the reply message to the client device 302 via the messaging platform 304, at flow 6. In some examples, agents are capable of sending messages to client devices other than the device that initiated the request. Thus, in some examples, flow 6 results in the reply message being sent to a different client device than the client device that initiated flow 1.

In some examples, when direct messaging is used, the agents themselves perform thread management. The first agent 306 uses skills to create the thread and the message but does not stay idle while waiting for replies from other agents. The other agents 318, 322 reply to the first agent 306 subsequently when their respective skills 316, 320 are finished. This call pattern enables the agents 318, 322 to engage in longer latency tasks independently of the first agent 306, such as tasks that involve calls to GMLMs for reasoning tasks, or tasks that require long running conversations with as many requests and response messages as are needed for the respective skills to complete.

The examples shown in FIG. 3 and the accompanying description are provided for illustration purposes. This disclosure is not limited to the described examples.

FIG. 4 is a component-based flow diagram of an example method for managing communications between agents of a multi-agent system in accordance with some examples of the present disclosure.

FIG. 4 provides an example of asynchronous skill invocation that uses messages to write the task, also referred to as an intent, to a thread before an asynchronous skill is called to improve reliability of the asynchronous processing. The tracking of the task using messages allows the skill to be executed in a manner that is ensured to complete. [if possible please say why the tracking ensures the skill completes] The method 400 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 400 is performed by the computing system components shown in FIG. 1, FIG. 2, FIG. 3, FIG. 4, FIG. 5, FIG. 6, one or more components of computing system 800 of FIG. 8, or agent system 980 of FIG. 9. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

The method 400 illustrates an example of asynchronous time bound skill invocation in a multi-agent system. When the method 400 is used to invoke skills, the managing agent is able to ensure the completion of skill executions as long as the skills satisfy one or more criteria that make them suitable for asynchronous time bound invocation. In some examples, the criteria for using asynchronous time bound skill invocation includes the execution time for the skill not exceeding a threshold amount of time, such as sixty seconds. The asynchronous time bound skill invocation provides reliability and is robust to traffic shift issues for skills that satisfy the criteria.

Typically, asynchronous function calls are unable to ensure reliability because there is some risk that the call will not return to the agent. To address this challenge, in the method 400, a managing agent leverages a messaging platform to track the status of skill invocations.

At flow 1, a messaging platform 406 receives a task from a client device 402 via a client UI layer 404. The messaging platform 406 ensures delivery of the task to the managing agent 410, with one or more retries 408 if needed. The managing agent 410 invokes a task agent 422 to perform the task via a managing agent plugin 412, agent invocation 418, and retry API 414 as needed. Agent invocation retries 420 and message communication events are logged to data store 416, using, e.g., stream processing. The agent invocation 418 includes a message ( ) call 424 to the task agent 422 via the messaging platform 406, at flow 2.

The task agent 422 determines that a skill needed to perform the task satisfies the criteria for asynchronous time bound invocation and starts the asynchronous skill invocation 430 via a skill invocation API call 433 to the managing agent 432. At flow 4, using the messaging platform 434, the managing agent 432 creates an asynchronous skill thread 436 and a new skill request message, e.g., M1, indicating that a skill is being invoked. Responsive to the creation of the skill thread 436, the managing agent 448 performs the asynchronous skill invocation 452 via a skill management plugin 450, at flow 5. At flow 6, the managing agent 440 determines that the skill execution is finished and creates a response message using the messaging platform 454. The response message, e.g., M2, is added to the skill thread 436. The addition of the response message to the skill thread 436 is communicated to the managing agent 440 via the messaging platform 438, at flow 7.

If only one skill is invoked, the individual skill returns the skill response ( ) 428 to the task agent 426 via task agent callback API 446 to inform the task agent 426 that the task results are ready. If two or more skills are invoked in batch, a batch skill invocation iteratively checks the collection of results from the skills in the batch until all skills in the batch are finished and only uses the task agent callback 446 to communicate the batch results to the task agent 426 when all of the results from all of the skills in the batch are ready, at flow 8. Following flow 8, the task agent 426 returns the results to the client device 402 via the messaging platform 406.

Different reference numbers have been assigned to elements shown in FIG. 4 to indicate different states of the same element. For example, managing agent 432 is the same component as managing agent 410 but shown in a different state or instance, messaging platform 434 is the same component as messaging platform 406 shown in a different state or instance, and so on.

The criteria for determining whether a skill is suitable for time bound asynchronous invocation corresponds to constraints associated with the messaging platform 406, in some examples. The messaging platform 406 specifies a maximum time interval for an agent to receive a reply to a message, in some examples; thus, the skill execution needs to complete within that time interval as well.

The creation of the skill thread 436 enables the managing agent 432 to ensure that an asynchronous skill has the ability to complete in the appropriate amount of time, even with failures. In some examples, all of the components of the asynchronous skill invocation 430 are included in a single function call that is conditioned on the managing agent logging the skill invocation in the skill thread 436. The return of the function call to the task agent 426 is also conditioned on the managing agent logging the response message in the skill thread 436.

Because the skill invocation and the return of the response are conditioned on the writes to the skill thread 436, this portion of the skill invocation at flow 5 is synchronous because the response is in the same thread as the skill invocation. When the response is returned on the skill thread 436, the managing agent 440 ensures that the response is returned to the task agent 426 via the skill management plugin 442. Thus, the managing agent uses the skill thread 436 to ensure that the skill executes and that the response is returned. However, once the managing agent 440 has created the skill thread 436, the managing agent does not have to wait for the skill to return. Instead, the managing agent is capable of performing other tasks or invoking other skills in parallel with the skill execution.

The examples shown in FIG. 4 and the accompanying description are provided for illustration purposes. This disclosure is not limited to the described examples.

FIG. 5 is a component-based flow diagram of an example method for managing communications between agents of a multi-agent system in accordance with some examples of the present disclosure.

FIG. 5 illustrates an example of using the managing agent rather than the memory capabilities of the messaging platform or orchestration layer to ensure reliability of asynchronous communications. In some examples of FIG. 4, an orchestration layer controls the thread management to ensure reliability of the asynchronous skills. In FIG. 5, the managing agent ensures reliability, e.g., without using thread management. The method 500 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 500 is performed by the computing system components shown in FIG. 1, FIG. 2, FIG. 3, FIG. 4, FIG. 5, FIG. 6, one or more components of computing system 800 of FIG. 8, or agent system 980 of FIG. 9. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

The method 500 illustrates an asynchronous time-unbound skill invocation. The method 500 is usable for skill invocations that do not meet the criteria for the time-bounded skill invocation, such as skills that are likely to take longer than a threshold time duration to finish executing. In some examples, the method 500 is used to handle skills that involve calls to GMLMs, whereas the method 400 is used to handle skills that perform simple look ups or short queries.

In the time-unbound skill invocation, the managing agent hands off control to the skill agent and relies on the skill agent to send a return communication to the managing agent when the skill agent is finished executing. This allows the managing agent to do other things while the skills are executing and enables the skills to respond to the managing agent either in the same thread or in a different thread when the skill has completed its time-unbound execution.

At flow 1, a messaging platform 506 receives a task from a client device 502 via a client UI layer 504. The messaging platform 506 ensures delivery of the task to the managing agent 510, with one or more retries 508 if needed. The managing agent 510 invokes a task agent 522 to perform the task via a managing agent plugin 512, agent invocation 518, and retry API 514 as needed. Agent invocation retries 520 and message communication events are logged to data store 516, using, e.g., stream processing. The agent invocation 518 includes a message ( ) call 524 to the task agent 522 via the messaging platform 506, at flow 2.

The task agent 522 determines that a skill needed to perform the task is capable of being executed using asynchronous time-unbound invocation and starts the asynchronous skill invocation 530 via an async API call 534 to the managing agent 532, at flow 3. Also at flow 3, the managing agent 532 looks up the task agent's callback information from the skill registry 536 and passes the task agent's callback information to the skill agent via async skill callback name 538 and async API 534. The skill agent 544 acknowledges the call back to the managing agent 532 and then from that point forward at flow 4 to flow 5, the skill agent 544 is in charge of ensuring that the skill execution finishes and that the managing agent receives a response.

Thus, the unbounded asynchronous skill invocation 530 hands off responsibility for all execution guarantees to the skill agent 544 and allows the skill agent 544 to take as long as is needed to finish execution. In the example of FIG. 5, the skill execution includes execution of multiple skills 546, 548, an API 550, and one or more other calls referred to in the drawing as etc. 552. The managing agent 540 is only called when the skill agent 554 is ready to return a complete response to the task agent 526 via the managing agent 532 and a deferred skill response API 542, at flow 6. The skill agent 554 passes the task agent's callback information back to the managing agent 540, and the managing agent 540 communicates the skill response ( ) 528 to the corresponding task agent 526, which initiated the skill at flow 2.

The skill invocation 530 is fully asynchronous. The task agent 522 and the managing agent 532 can perform other tasks or skills once the call to the skill agent 544 is made at flow 4.

Different reference numbers have been assigned to elements shown in FIG. 5 to indicate different states of the same element. For example, managing agent 532 is the same component as managing agent 510 but shown in a different state or instance, and so on.

The examples shown in FIG. 2 through FIG. 5 provide for flexible implementations of the managing agent. In some examples, the implementation is selected dynamically based on characteristics of a given task or computing environment.

The examples shown in FIG. 5 and the accompanying description are provided for illustration purposes. This disclosure is not limited to the described examples.

FIG. 6 is a schematic diagram of an example schema for a registry in accordance with some examples of the present disclosure.

The registry 600 stores information about skill agents, also referred to as skills, and task agents. In the registry 600, each row corresponds to a data record for a different skill agent or task agent, as the case may be. The registry 600 is capable of including any number of rows and the number of rows is not limited to three. Each column of the registry 600 corresponds to a field or piece of data associated the data record in the respective row. The pieces of data tracked and stored in registry 600 include an identifier, name, location, specifications, call, input parameters, and output parameters.

The location corresponds to the geographic location of the distributed component of the distributed system at which the agent resides. The specifications indicate the type of invocation to be used to invoke the agent and/or information about dependencies associated with the agent. In some examples, the specifications indicate the type of skill invocation to be used for a skill agent. For a task agent, the specifications identify skills included in the task executed by the task agent, in some examples.

The call provides the API call or other communication that is to be used to invoke the skill agent or task agent as the case may be. The input parameters and output parameters identify the inputs to be included in the call and the outputs to be produced by execution of the call.

The registry 600 is exemplary. Other examples include other pieces of information alternatively or in addition to the information described with respect to the registry 600. The registry 600 enables managing agents of a multi-agent system to select appropriate agents for different tasks and computing environments.

The examples shown in FIG. 6 and the accompanying description are provided for illustration purposes. This disclosure is not limited to the described examples.

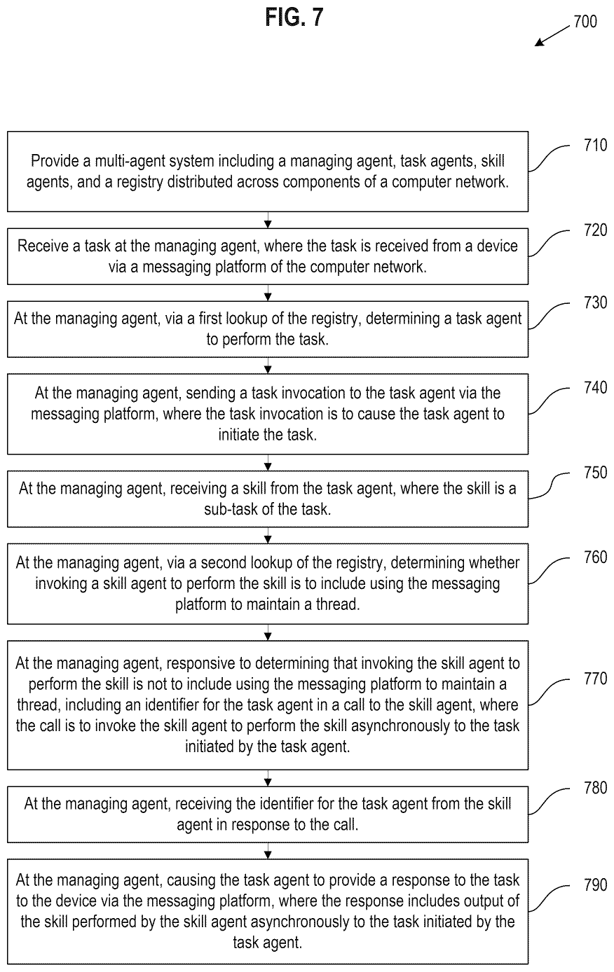

FIG. 7 is a flow diagram of an example method for managing communications among agents of a multi-agent system in accordance with some examples of the present disclosure.

The method 700 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 700 is performed by the computing system components shown in FIG. 1, FIG. 2, FIG. 3, FIG. 4, FIG. 5, FIG. 6, one or more components of computing system 800 of FIG. 8, or agent system 980 of FIG. 9. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

At operation 710, the processing device provides a multi-agent system. The multi-agent system includes a managing agent, task agents, skill agents, and a registry distributed across components of a computer network.

At operation 720, the processing device receives a task at the managing agent. The task is received from a device via a messaging platform of the computer network, in some examples.

At operation 730, the processing device, at the managing agent, via a first lookup of the registry, determines a task agent to perform the task.

At operation 740, the processing device, at the managing agent, sends a task invocation to the task agent via the messaging platform. The task invocation is to cause the task agent to initiate the task, in some examples.

At operation 750, the processing device, at the managing agent, receives a skill from the task agent. The skill is a sub-task of the task, in some examples.

At operation 760, the processing device, at the managing agent, via a second lookup of the registry, determines whether invoking a skill agent to perform the skill is to include using the messaging platform to maintain a thread.

At operation 770, the processing device, at the managing agent, responsive to determining that invoking the skill agent to perform the skill is not to include using the messaging platform to maintain a thread, includes an identifier for the task agent in a call to the skill agent. The call is to invoke the skill agent to perform the skill asynchronously to the task initiated by the task agent, in some examples.

At operation 780, the processing device, at the managing agent, receives the identifier for the task agent from the skill agent in response to the call.

At operation 790, the processing device, at the managing agent, causes the task agent to provide a response to the task to the device via the messaging platform. The response includes output of the skill performed by the skill agent asynchronously to the task initiated by the task agent, in some examples.

The examples shown in FIG. 7 and the accompanying description are provided for illustration purposes. This disclosure is not limited to the described examples.

FIG. 8 is a flow diagram of an example component-based method for configuring and/or operating an agent using components of an agent system in accordance with some examples of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method is performed by components of distributed multi-agent system 805, such as components or flows shown in FIG. 8 that are not specifically shown in other figures and/or components or flows shown in other figures that are not specifically shown in FIG. 8. Although shown in a particular sequence, arrangement, or order, unless otherwise specified, the order and/or arrangement of the components and/or processes is modifiable. In some examples, the illustrated examples should be understood only as examples, and the illustrated processes are capable of being performed in a different order, and some processes are capable of being performed in parallel. Additionally, one or more processes are omitted in various examples. Thus, not all processes are required in every example. Other process flows are possible.

In FIG. 8, an example computing system 800 is shown, which includes an automated agent 802. The automated agent 802 is in communication with various elements of an environment 801, including a user device 801A, a network 801B, and/or one or more sensing devices 801C. Examples of user devices 801A include computing devices, such as laptop computers, smart phones, mobile computing devices, smart appliances, wearable devices, game controls, vehicle controls, etc. Examples of networks 801B include wireless, optical, and wired communication networks. Examples of sensors include motion sensors, load cells, force sensors, temperature sensors, and network sensors.

In some examples, the user device 801A is in communication with one or more applications 804 directly and/or via the automated agent 802. The automated agent 802 is supported by and in communication with one or more of the applications 804 and/or a distributed multi-agent system 805. In some examples, responsive to receiving input via one or more components of the environment 801, the automated agent 802 is dynamically configured or reconfigured to perform a task or a series of tasks, via one or more components of the distributed multi-agent system 805.

In the example of FIG. 8, the components of the computing system 800 are implemented using an application server or server cluster. In some examples, the computing system 800 includes a secure environment (e.g., secure enclave, encryption system, etc.) for the processing of data. In other examples, one or more components of the computing system 800 are implemented on a client device, such as a user system 910, described herein with reference to FIG. 9. In some examples, some or all of computing system 800 is implemented directly on a user's device or within an embedded system, thereby avoiding the need to communicate with servers over a network such as the Internet.

In some examples, the distributed multi-agent system 805 is in bidirectional communication with one or more applications 804, e.g., directly or via a computer network. In some examples, the one or more applications 804 include user interface functionality that is considered part of or is in communication with automated agent 802 and/or distributed multi-agent system 805. Illustrative, nonlimiting examples of applications that are included in the applications 804 in some examples include search engines 804A, social networks 804B, and/or domain applications 804C. Some examples include other applications alternatively or in addition to search engines 804A, social networks 804B, and domain applications 804C. In some examples, search engines 804A include general-purpose search engines such as Internet search engines and/or domain-specific search engines, e.g., search engines designed specifically for job searching or entity profile searching. In some examples, social networks 804B include general purpose social networks and/or domain-specific social networks such as professional or job-related social networks. Examples of domain applications 804C include user-facing applications such as job posting services, content distribution services, recruiting tools, ecommerce systems, email and messaging systems, enterprise applications, etc. Other examples of domain applications include embedded systems such as device control systems, e.g., navigation systems and robotic systems, as well as other types of sensor-based systems such as augmented reality and mixed reality systems.

In the example of FIG. 8, the distributed multi-agent system 805 includes a plurality of sub-agents 806A, 806B, . . . , 806N, a communication service 808, an adaptive machine learning service 810, and a multi-layer memory structure 811. Any reference to N herein refers to an Nth element of a device, component, system, or process, where N is a positive integer and the value of Nis variable depending on the context. For example, in FIG. 8, the computing system 800 includes N applications 804, N sub-agents 806, N memory layers, N context models, N artificial intelligence services 814, N data resources 816, and N tools 818, where N is capable of having the same value or different values for each or any reference to N.

The sub-agents 806A, 806B, . . . , 806N cooperate and coordinate with each other to perform tasks on behalf of the user. In some examples, each sub-agent 806A, 806B, . . . , 806N has an assigned role or function, such as a profile sub-agent, a planner sub-agent, a workflow sub-agent, a memory sub-agent, or any other sub-agent that is capable of communicating with the automated agent 802 in executing tasks and fulfilling user requests or goals.

Any sub-agent 806A, 806B, . . . , 806N includes or is defined by a combination of computer code, data, memory, AI services 814, data resources 816, and/or tools 818, which are arranged or configured to perform a specific task or action. In some examples, a sub-agent 806A, 806B, . . . , 806N has or includes an associated agent profile, planner, workflow, and memory. The sub-agent's memory is allocated to the sub-agent via the multi-layer memory structure 811. The sub-agent's profile is capable of being pre-defined or configured dynamically using data obtained from one or more data resources 816. In some examples, the sub-agent's profile references one or more registries 816B, which identify one or more of the workflows 816A, memories 812, AI services 814 and/or tools 818 that are accessible to the sub-agent and are usable by the sub-agent to perform the task identified in the sub-agent's profile.

Portions of each or any of the sub-agents 806A, 806B, . . . , 806N communicate with each other and/or adaptive machine learning service 810, multi-layer memory structure 811, artificial intelligence services 814, data resources 816, tools 818, and with the automated agent 802, via a communication service 808. Communication service 808 facilitates data exchange and message passing among the components of the distributed multi-agent system 805 and/or components of the computing system 800. Examples of communication service 808 include asynchronous messaging capabilities, which, in some examples, include a publish and subscribe messaging protocol. In some examples, communication service 808 is implemented using, e.g., an agent framework or GAI application having containerized endpoints such as REST (representational state transfer) or gRPC (remote procedure call) that is capable of messaging. In some examples, use of asynchronous messaging is helpful for error handling by, for example, preventing infinite loops and enabling agent processes to be stopped at any time.

In some examples, the automated agent 802 or any sub-agent 806A, 806B, . . . , 106N accesses and interfaces with an adaptive machine learning service 810. In some examples, a sub-agent invokes adaptive machine learning service 810 to determine whether a task, request, goal, or objective has been fulfilled and/or to determine whether to dynamically modify a task, workflow or plan. In some examples, adaptive machine learning service 810 includes or interfaces with one or more machine learning models including a Bayesian inference learning mechanism. In some examples, a Bayesian model is constructed that predicts a user's likely responses to output produced by the automated agent 802, using historical examples of the user's online activity to generate a prior probability distribution. In some examples, the automated agent 802 uses predictions of user behavior obtained via the Bayesian model to determine how to perform a task, which output to present to the user, and/or how to present output to the user. After the automated agent 802 performs a task and/or presents output to the user, based on the predictions obtained from the Bayesian model, the automated agent 802 monitors the user's actual response to the task performed and output produced by the automated agent 802. The user's actual response is used to update the Bayesian model, e.g., to generate a posterior probability distribution of the user's likely response. On the iteration or use of the sub-agent, the posterior probability distribution becomes the prior distribution from which updated predictions of user behavior are obtained.

In some examples, the automated agent 802 or any sub-agent 806A, 806B, . . . , 806N is implemented as a stateful, LM- and/or LLM-based multi-actor application with built-in persistent memory. Some examples use LMs and/or LLMs in different contexts. Some examples use LMs to enable agents to perform discrete tasks. References to LLM herein are representative of some examples; in other examples, LMs are used alternatively or in addition to the LLMs.

Examples of tools that are usable to construct the automated agent 802 or any sub-agent 806A, 806B, . . . , 806N include directive acyclic graph (DAG)-based frameworks and cycle-based frameworks such as LANGGRAPH. In some examples, portions of multi-layer memory structures described herein are implemented using the persistent memory features of LANGGRAPH or other frameworks that enable the integrating of persistent memory with application processes and workflows.

Examples of the automated agent 802 or any sub-agent 806A, 806B, . . . , 106N include semi-autonomous cognitive artificial intelligence that learns through interactions with human users. Some examples are data-driven and include hierarchical planners, automatic prompt engineering, code generation, and API discovery. Some examples include the use of large action models (LAMs), which are capable of selecting skills given a task or goal using one or more GMLMs that are specifically trained or tuned on APIs that are capable of being invoked as skills. Some examples use a layered memory system implemented using persistent memory structures that is integrated into agents and workflows. In some examples, document databases, document-oriented databases, column-oriented data stores, or document stores, such as NOSQL document stores, are used to implement portions of the multi-layered memory structures. In some examples, portions of the multi-layer memory structure are accessed, referenced, read from or written to using an abstract interface using, e.g., JSON path expressions. Examples operate asynchronously and are distributed, as described in more detail herein.

Workflow refers to an arrangement, sequence, or series of tasks that can be used by an agent to respond to a request or complete a goal or objective, from which an agent selects one or more specific tasks to complete a request, goal, or objective. In some examples, given the same or similar request, goal, or objective, a workflow includes multiple different tasks that are selectable to complete the request, goal, or objective, depending upon the applicable context data. In some examples, a workflow provides an agent with multiple different options for how to complete a request, goal, or objective and the agent uses the currently provided context data to select from among those options in a given instance.

Workflows are capable of being generalized or task-specific. Examples of generalized workflows include workflows that build or update a context model, workflows that build or update an agent profile, and workflows that read and write data to and from portions of multi-layer memory structures (e.g., to store user feedback in procedural memory). Another example of a generalized workflow is a workflow that obtains the inputs required to invoke an agent, e.g., to obtain relevant context, interaction history, learned preferences, etc., to parameterize an action (e.g., a specific task of a workflow performed by an agent). The parameterization of actions enables the actions to be configured and customized dynamically using the most current relevant information. In some examples, when an action is invoked, a workflow is executed that obtains the relevant context, historical data, and learned preferences from memory and parameterizes the action with that information. Other examples of generalized workflows include workflows for performing adaptive machine learning processes to build context models (e.g., models of users and environments), updating semantic memory, and translating interaction experiences into procedural memory.

In some examples, plan refers to a specific arrangement, sequence, or series of tasks that have been selected by an agent from among one or more available workflow options to complete a task, goal, or objective. Given the same or similar request, goal, or objective, an agent selects one set of tasks to complete the request, goal, or objective in a first context and a different set of tasks to complete the same or similar request, goal, or objective in a second, different context, in some examples. A plan is capable of including a specific ordering of tasks, i.e., instructions as to which task the agent is to perform first, second, third, etc.

In some examples, the automated agent 802 or any sub-agent 806A, 806B, . . . , 806N accesses and interfaces with one or more layers of multi-layer memory structure 811. In the example of FIG. 8, multi-layer memory structure 811 includes a plurality of layers, such as a working memory 812A, an episodic memory 812B, and a collective memory 812C. In other examples, other types of memory layers are used and/or the number of memory layers is configurable depending upon the requirements of a particular design or implementation.

In some examples, each of automated agent 802 and every sub-agent 806A, 806B, . . . , 806N has its own multi-layer memory structure 811 (e.g., keyed off the agent's unique agent identifier).

In some examples, the different layers of multi-layer memory structure 811 store and manage different types of context models 813A, 813B, . . . , 813N according to their respective scope, duration, relevance, and/or other criteria. In some examples, the working memory 812A stores context models 813A, 813B, . . . , 813N that are related to the current dialog or task, the episodic memory 812B stores context models 813A, 813B, . . . , 813N that are related to previous dialogs or tasks, and the collective memory 812C stores context models 813A, 813B, . . . , 813N that are related to general or domain knowledge.

A context model refers to a representation of the state or situation of the automated agent 802, the user, the application 804, or the dialog between the user and the automated agent 802, or a combination of any of the foregoing, at a particular instance, timestamp, or time interval associated with operation of the computing system 800 or automated agent 802, which is created with and/or includes context data. In some examples, a context model includes various types of information, such as preferences, policies, profile data, historical user activity data, sensor data, network data, model parameters, and/or any other data that is usable to configure an agent, workflow, plan, or task. Some examples create, initialize and/or update a context model for a user associated with an automated agent 802 by extracting information from the user's online profile (e.g., a profile page and/or the user's online activity history on a social network). In some examples of physical devices that are controlled by the automated agent 802, a context model includes sensor data collected via sensors associated with the physical devices and control signals generated by components of the devices.

Examples of context data include data logged during a user's use of an automated agent 802 and/or one or more applications 804, such as data input, output, or interacted with, the timestamp at the user's login in to the application, and actions taken by the user during the login session, including implicit and/or explicit user interactions with the application's user interface elements. Alternatively or in addition, context data refers to historical data logged during the user's prior uses of one or more applications and/or aggregate data that represents usage statistics across a group or population of users of the application. In some examples, context data includes implicit signals such as a count of the number of times content has been presented to the user, the number of times users interacted with content provided by the system, or the latency in the user's response to content. In some examples, context data includes explicit signals such as explicit reactions (e.g., thumbs-up, thumbs-down, comments, shares, follows) and/or other explicit or implicit feedback signals. In some examples, context data is used to dynamically configure agents, workflows, tasks, and plans.

The number of context models is not limited and is configurable depending upon the requirements of a particular design or implementation. Any portions of any one or more of context models 813A, 813B, 813C are capable of being stored in any one or more of the memory layers 812A, 812B, 812C. In some examples, a first context model including data from device 801A is stored in working memory 812A while a second context model including data from network 801B and/or one or more sensors 801C is in episodic memory 812B and a third context model including data from one or more automated agents 802 or sub-agents 806A, 806B, . . . , 806N is stored in collective memory 812C.

In some examples, a first context model including a first combination of data obtained from device 801A, network 801B, and/or sensors 801C over a first time interval is stored in working memory 812A while a second context model including a second combination of data obtained from device 801A, network 801B, and/or sensors 801C over a second time interval is stored in episodic memory 812B and a third context model including a third combination of data obtained from device 801A, network 801B, and/or sensors 801C over a third time interval is stored in collective memory 812C, where the first, second, and third context models, combinations of data, and/or time intervals are respectively different.

Also or alternatively, different portions of the multi-layer memory structure 111 are capable of being used to store context data for different automated agents 802 and/or sub-agents 806A, 806B, . . . , 806N. In some examples, different portions of the working memory 812A and/or episodic memory 812B are used to store context data for different automated agents 802 and/or different portions of the collective memory 812C are used to store context data and/or output generated by one or more sub-agents 806A, 806B, . . . , 806N. In some examples, if an action performed by a first sub-agent 806A, 806B, . . . , 806N is dependent upon output of an action of a second sub-agent 806A, 806B, . . . , 806N, collective memory 812C is used to store the output of the second-sub-agent in a memory layer that is accessible by the first sub-agent.

Any one or more of automated agent 802, applications 804 and/or portions of distributed multi-agent system 805 is capable of interfacing or communicating with any one or more of artificial intelligence (AI) services 814, data resources 816, and/or tools 818 either directly or via a communication service 808 that provides artificial intelligence (AI) services 814 and data resources 816 to the automated agent 802. Any of the AI services 814, data resources 816, and/or tools 818 is capable of being a component of the distributed multi-agent system 805 or a separate component, such as a hosted service.

The AI services 814 include various types of machine learning models and/or algorithms that are capable of enhancing the capabilities and performance of the automated agent 802, such as but not limited to one or more large language models (LLMs) 814A, Bayesian inference learning (BIL) models 814B, and machine learning (ML) models 814C, or any other AI service that are capable of providing, for instance, natural language understanding, natural language generation, dialog management, task execution, intent classification, entity extraction, information extraction, code generation, embedding generation models, similarity prediction, scoring, and/or any other function related to the operation of the automated agent 802 or any sub-agent.

A large language model 814A has an associated model type, architecture, and configuration, associated arguments, and associated micro-prompts, where the arguments are placeholders for information, such as context data, to be inserted into the micro-prompts. Micro-prompts are LLM prompts that are tailored for domain- or task-specific (e.g., fine-tuned) language models. In some examples, a micro-prompt includes a particular combination or arrangement of instructions, constraints, examples, and/or parameters or arguments that is configured specifically to cause a particular domain- or task-specific language model to produce a particular type of output while avoiding or reducing the risk of AI hallucination. In some examples, a micro-prompt is configured to cause a language model to perform a specific atomic action such as to generate a query to access one or more layers of a layered memory structure, or to map data retrieved from a layered memory structure to arguments of another prompt.

In some examples, a language model or large language model type, architecture, and configuration includes one or more neural network-based machine learning models. In some examples, a large language model 814A is constructed using a neural network-based deep learning model architecture. In some examples, the neural network-based architecture includes one or more input layers that receive model inputs, generate one or more embeddings based on the model inputs, and pass the one or more embeddings to one or more other layers of the neural network. In other examples, the one or more embeddings are generated based on the model input by a pre-processor, the embeddings are input to the neural network model, and the neural network model generates output based on the embeddings.

In some examples, the neural network-based machine learning model architecture includes one or more self-attention layers that allow the model to assign different weights to portions of the model input. Alternatively or in addition, the neural network architecture includes feed-forward layers and residual connections that allow the model to machine-learn complex data patterns including relationships between different portions of the model input in multiple different contexts. In some examples, the neural network-based machine learning model architecture is constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation of the distributed multi-agent system 805.

In some examples, the neural network-based machine learning model architecture includes or is based on one or more generative transformer models, one or more generative pre-trained transformer (GPT) models, one or more bidirectional encoder representations from transformers (BERT) models, one or more language models (LMs), one or more large language models (LLMs), one or more large action models (LAMs), one or more XLNet models, and/or one or more other natural language processing (NL) models. In some examples, the neural network-based machine learning model architecture includes or is based on one or more predictive text neural models that receive text input and generate one or more outputs based on processing the text with one or more neural network models. Examples of predictive neural models include, but are not limited to, Generative Pre-Trained Transformers (GPT), BERT, and/or Recurrent Neural Networks (RNNs). In some examples, one or more types of neural network-based machine learning model architectures include or are based on one or more multimodal neural networks capable of outputting different modalities (e.g., text, image, video, sound, etc.) separately and/or in combination based on textual input. Accordingly, in some examples, a multimodal neural network implemented in the agent system is capable of outputting digital content that includes a combination of two or more of text, images, video or audio.

In some examples, a large language model 814A is trained on a large dataset of digital content such as natural language text, images, videos, audio files, or multi-modal data sets. For example, training samples of digital content such as natural language text extracted from publicly available data sources are used to train one or more generative models used by the agent system. The size and composition of the datasets used to train one or more models used by the agent system are variable according to the requirements of a particular design or implementation of the agent system. In some examples, one or more of the datasets used to train one or more models used by the agent system includes hundreds of thousands to millions or more different training samples.

In some examples, one or more models used by the agent system include multiple generative models trained on differently sized datasets. In some examples, an agent system includes a comprehensive but low capacity generative model that is trained on a large data set. In some examples, the same generative model includes a less comprehensive but high capacity model that is trained on a smaller data set, and the high capacity model is used to generate outputs based on examples obtained from the low capacity model. In some examples, reinforcement learning is used to further improve the output of one or more models used by the agent system. In reinforcement learning, ground-truth examples of desired model output are paired with respective inputs, and these input-example output pairs are used to train or fine tune one or more models.

In some examples, prompt refers to one or more instructions that are readable by a GAI model, such as a large language model 814A, along with the input to which the GAI model is to apply the instructions, and a set of parameter values that constrain the operations of the GAI model during the processing of the prompt and generating and outputting a response to the prompt. In some examples, the prompt input includes user input and/or context data. In some examples, the prompt input is specified explicitly in the prompt or as a reference that is processed at execution time. In some examples, the prompt instructions include one or more statements, questions, conditions, constraints, or prompt examples. Some instructions include prompt examples, which are illustrative examples of the types of output to be produced by the GAI model and/or examples of the types of processing steps the large language model is to perform in order to generate output.

In some examples, the parameter values contained in the prompt are specified by the GAI model and are adjustable in accordance with the requirements of a particular design or implementation. Examples of parameter values include the maximum length or size of the prompt and the temperature, or degree to which the model produces deterministic output versus random output. The way in which the elements of the prompt are organized and the phrasing used to articulate the prompt elements is capable of significantly affecting the output produced by the GAI model in response to the prompt. In some examples, a small change in the prompt content or structure is capable of causing the GAI model to generate a very different output.

Zero-shot prompt refers to a type of large language model prompt that does not include any prompt examples, e.g., the prompt only includes an input and a task description that does not include any examples to guide the large language model as to how to perform the task. An example of a zero-shot prompt is “classify the user input [input1] into action_a, action_b, or action_c,” where [input1] is a placeholder for the user input and/or associated context data and action_a, action_b, and action_c are possible intents into which the large language model is capable of classifying input1. A few-shot prompt includes examples along with an instruction to cause the large language model to follow the examples provided when processing an input. An example of a few-shot prompt is “‘software engineering’→job_search; ‘fill’→job_candidate_search; what is the intent of [input1]?” where ‘software engineering’→job_search and ‘fill’→job_candidate_search are examples of how to classify inputs into search categories, and input1 includes user input and/or context data.

In some examples, a chain-of-thought prompt refers to a type of large language model prompt that includes an input and a prompt example that includes the types of steps the large language model is to perform, such as intermediate steps or reasoning. In some examples, the chain-of-thought prompt includes a series of steps that illustrate to the large language model a process for how to select functions or logical groupings of functions to be included in a plan.

The data resources 816 include various types of data or information that are capable of being used by the automated agent 802, any sub-agent 806A, 806B, . . . , 806N, any of the AI services 814, or any of the tools 818. Examples of data resources 816 include but are not limited to workflows 816A, registries 816B, data stores 816C, and/or any other data resource that provides knowledge, facts, rules, policies, preferences, or any other information related to the applications 804, the user, the environment 801, and/or the domain of the automated agent 802.

Registries 816B include, e.g., files, lookup tables, or databases that store information about which AI services 814, data resources 816, and/or tools 818 are accessible to a particular automated agent 802. In some examples, different automated agents 802 have different associated registries 816B and the contents of the same type of registry is different for different automated agents (e.g., the contents of respective workflow registries is different for different agents). Data stores 816C include but are not limited to embedding data stores or vector stores (e.g., data stores that store embeddings, i.e., compressed or vector representations of data) and/or other kinds of searchable data stores.

The data resources include, alternatively or additionally, entity profile data (e.g., profile data for a device, robot, vehicle, network, etc., company profiles, job postings, etc.), activity data (e.g., historical interaction data such as search histories, chat histories, and/or interaction histories associated with the user's use of applications 804), digital content, including documents and other content items that are accessible via Internet search engines, such as web pages and multimedia content, taxonomies, data stores, services, or artificial intelligence models, entity graphs and knowledge graphs, applications 804, such as other vertical applications and/or external applications which are in communication with the automated agent 802, and metrics, such as performance metrics associated with an AI service, such as a large language model, or any of the data resources or tools. Entity profile data includes current and/or historical attribute data associated with the user (e.g., user preferences and/or biographical data such as skills, work experiences, and education history) or another entity associated with the user (such as a company or a computing resource).

The tools 818 include various types of software and/or hardware components that facilitate operation of the automated agent 802 and/or the interaction of the automated agent 802 with the AI services 814 and/or the data resources 816. Examples of tools 818 include but are not limited to application programming interfaces (APIs) 818A, search tools 818B, functions 818C, or any other software and/or hardware component that provide access, retrieval, processing, or manipulation of data or information for the automated agent 802.

In operation, the distributed multi-agent system 805 creates and initializes an instance of the automated agent 802 in response to one or more inputs, signals, or events obtained from the environment 801, in cooperation with one or more applications 804, if applicable, and using one or more AI services 814, data resources 816, and/or tools 818. The automated agent 802 receives input expressed as structured language and/or conversational natural language, such as text, speech, or gesture. The input indicates a request, a command, a query, feedback, or any other type of input. The input is capable of being associated with context data, such as a timestamp, a geographic location, a device, network, or session identifier, a topic, a goal, or any other information that is capable of affecting the interpretation of the input by the automated agent 802 or the response generated by the automated agent 802 to the input.

To generate a response to the input, the automated agent 802 invokes one or more sub-agents of the distributed multi-agent system 805. In some examples, a planner sub-agent of the distributed multi-agent system 805 is invoked to generate a plan for responding to the input using as input a workflow, a profile, and a context model obtained from one or more of the memory layers. In some examples, the plan includes a plurality of actions that need to be performed (e.g., in sequence or in parallel), where each action has an associated action sub-agent. In some examples, each action sub-agent operates in a similar manner as the planner sub-agent. An action sub-agent generates a sub-plan for performing its assigned action in a similar manner as the planner sub-agent generates the plan, in some examples. Thus, the distributed multi-agent system 805 is capable of providing hierarchical planning in which any plan is capable of being expanded to include a plurality of sub-plans, where each sub-plan is performed by a sub-agent and the output is returned to the planner agent or the calling sub-agent, as the case may be. At any level of the planning hierarchy, the respective agent 802 or sub-agent 806 coordinates the generation and execution of the respective plan and any sub-plans.

The examples shown in FIG. 8 and the accompanying description, above are provided for illustration purposes. This disclosure is not limited to the described examples.

FIG. 9 is a block diagram of a computing system that includes an agent system in accordance with some examples of the present disclosure.

In the example of FIG. 9, a computing system 900 includes one or more user systems 910, a network 920, an application system 930, data resources and tools 950, an agent system 980, a data storage system 960, an event logging service 970, and an AI model service 990.

All or at least some components of agent system 980 are implemented at the user system 910, in some examples. For example, portions of agent system 980 are implemented directly upon a single client device such that communications involving applications running on user system 910 and agent system 980 occur on-device without the need to communicate with, e.g., one or more servers, over the Internet. Dashed lines are used in FIG. 9 to indicate that all or portions of agent system 980 are capable of being implemented directly on the user system 910, e.g., the user's client device. In some examples, both user system 910 and agent system 980 are implemented on the same computing device, in some examples. In other examples, all or portions of agent system 980 are implemented on one or more servers and in communication with user systems 910 via network 920. Components of the computing system 900 including the agent system 980 are described in more detail herein.

A user system 910 includes one or more computing devices. Examples of computing devices include a personal computing device, a server, a mobile computing device, a wearable electronic device, or a smart appliance. The user system 910 includes one or more software applications that a computing device is capable of executing alone or in combination with one or more other computing devices. Examples of software applications include an operating system or a front end of an online system. Many different user systems 910 are capable of being connected to network 920 at the same time or at different times. In some examples, different user systems 910 contain similar components as described in connection with the illustrated user system 910. In some examples, many different end users of computing system 900 interact with many different instances of application system 930 through their respective user systems 910, at the same time or at different times.

User system 910 includes a user interface 912. User interface 912 is installed on user system 910 or accessible to user system 910 via network 920. In some examples, user interface 912 includes a front end portion of an automated agent (e.g., automated agent 802) and/or agent system 980.

User interface 912 includes, for example, a graphical display screen that includes graphical user interface elements. Examples of graphical user interface elements include an input box or other input mechanism and a slot. A slot as used herein refers to a space on a graphical display such as a web page or mobile device screen, into which output, e.g., digital content such as search results, feed items, chat boxes, or threads, is loaded for display to the user. In some examples, user interface 912 includes a scrollable arrangement of variable-length slots that simulates an online chat or instant messaging session and/or a scrollable arrangement of slots that contain content items or search results. The locations and dimensions of a particular graphical user interface element on a screen are specified using, for example, a markup language such as HTML (Hypertext Markup Language). On a typical display screen, a graphical user interface element is defined by two-dimensional coordinates. In other examples such as virtual reality or augmented reality examples, a slot is defined using a three-dimensional coordinate system. Example screen captures of user interface screens that are capable of being included in user interface 912 are shown in the drawings and described herein.

User interface 912 is capable of interacting with the agent system 980 and/or one or more application systems 930. For example, user interface 912 enables the user of a user system 910 to interact with the automated agent 802 to create, edit, send, view, receive, process, and organize workflows, tasks, plans, search queries, search results, content items, news feeds, and/or portions of online dialogs. In some examples, user interface 912 enables the user to input requests (e.g., queries) for various different types of information, to initiate user interface events, and to view or otherwise perceive output such as data and/or digital content produced by, e.g., an application system 930, agent system 980, content distribution service 938 and/or search engine 940. In some examples, user interface 912 includes a graphical user interface (GUI), a conversational voice/speech interface, a virtual reality, augmented reality, or mixed reality interface, and/or a haptic interface. User interface 912 includes a mechanism for entering search queries and/or selecting search criteria (e.g., facets, filters, etc.), selecting GUI user input control elements, and interacting with digital content such as search results, entity profiles, posts, articles, feeds, and online dialogs, in some examples. Some examples of user interface 912 include web browsers, command line interfaces, and mobile app front ends. User interface 912 as used herein includes application programming interfaces (APIs) in some examples.

Network 920 includes an electronic communications network. Network 920 is implemented on any medium or mechanism that provides for the exchange of digital data, signals, and/or instructions between the various components of computing system 900. Examples of network 920 include, without limitation, a Local Area Network (LAN), a Wide Area Network (WAN), an Ethernet network or the Internet, or a terrestrial, satellite or wireless link, or a combination of any number of different networks and/or communication links.

Application system 930 includes, for example, one or more online systems that provide social network services, general-purpose search engines, specific-purpose search engines, messaging systems, content distribution platforms, e-commerce software, enterprise software, or any combination of any of the foregoing or other types of software. Application system 930 includes any type of application system that provides or enables the retrieval of and interactions with one or more forms of digital content, including machine-generated content via user interface 912. In some examples, portions of agent system 980 are components of application system 930. In some examples, an application system 930 includes one or more of an entity graph 932 and/or knowledge graph 934, a user connection network 15315, a content distribution service 938, and/or a search engine 940. In other examples, application system 930 interacts with agent system 980 to control a physical machine or device, such as a vehicle or a robot.

In some examples, a front end portion of application system 930 operates in user system 910, for example as a plugin or widget in a graphical user interface of a web application, mobile software application, or as a web browser executing user interface 912. In an example, a mobile app or a web browser of a user system 910 transmits a network communication such as an HTTP request over network 920 in response to user input that is received through a user interface provided by the web application, mobile app, or web browser, such as user interface 912. A server running application system 930 receives the input from the web application, mobile app, or browser executing user interface 912, performs one or more operations using the input, and returns output to the user interface 912 using a network communication such as an HTTP response, which the web application, mobile app, or browser receives and processes at the user system 910.

In the example of FIG. 9, an application system 930 includes an entity graph 932 and/or a knowledge graph 934. Entity graph 932 and/or knowledge graph 934 include data organized according to graph-based data structures that are searchable or traversable via queries and/or indexes to determine relationships between entities. In some examples, entity graph 932 and/or knowledge graph 934 is used to compute various types of relationship weights, affinity scores, similarity measurements, and/or statistics between, among, or relating to entities.

Entity graph 932, knowledge graph 934 includes a graph-based representation of data stored in data storage system 960, described herein. For example, entity graph 932, knowledge graph 934 represents entities, such as users, organizations (e.g., companies, schools, institutions), content items (e.g., job postings, announcements, articles, comments, and shares), and computing resources (e.g., databases, models, applications, and services), as nodes of a graph. Entity graph 932, knowledge graph 934 represents relationships, also referred to as mappings or links, between or among entities as edges, or combinations of edges, between the nodes of the graph. In some examples, mappings between different pieces of data used by an application system 930 are represented by one or more entity graphs. In some examples, the edges, mappings, or links indicate relationships, online interactions, or activities relating to the entities connected by the edges, mappings, or links. In some examples, if a user clicks on a search result, an edge is created connecting the user entity with the search result entity in the entity graph, where the edge is tagged with a label such as “viewed.” If a user viewing a list of search results skip over a search result without clicking on the search result, an edge is not created between the user entity and the search result entity in the entity graph, in some examples.

Portions of entity graph 932, knowledge graph 934 are automatically re-generated or updated from time to time based on changes and updates to the stored data, e.g., updates to entity data and/or activity data. In some examples, entity graph 932, knowledge graph 934 refers to an entire system-wide entity graph or to only a portion of a system-wide graph. In some examples, entity graph 932, knowledge graph 934 refers to a subset of a system-wide graph, where the subset pertains to a particular user or group of users of application system 930.

Knowledge graph 934 includes a graph-based representation of data stored in data storage system 960, described herein. Knowledge graph 934 represents relationships, also referred to as links or mappings, between entities or concepts as edges, or combinations of edges, between the nodes of the graph. In some examples, mappings between different pieces of data used by application system 930 or across multiple different application systems are represented by the knowledge graph 934.

In some examples, knowledge graph 934 is a subset or a superset of entity graph 932. In some examples, knowledge graph 934 includes multiple different entity graphs 932 that are joined by cross-application or cross-domain edges. In some examples, knowledge graph 934 joins entity graphs 932 that have been created across multiple different databases or across different software products. In some examples, the entity nodes of the knowledge graph 934 represent concepts, such as product surfaces, verticals, or application domains. In some examples, knowledge graph 934 includes a platform that extracts and stores different concepts that is used to establish links between data across multiple different software applications. Examples of concepts include topics, industries, and skills. As with other portions of entity graph 932, knowledge graph 934 is usable to compute various types of relationship weights, affinity scores, similarity measurements, and/or statistical correlations between or among entities and/or concepts.

In the example of FIG. 9, application system 930 includes a user connection network 936. User connection network 936 includes, for instance, a social network service, professional social network system and/or other social graph-based applications. Content distribution service 938 includes, for example, a feed, chatbot or chat-style system, or a messaging system, such as a peer-to-peer messaging system that enables the creation and exchange of messages between users of application system 930 and the application system 930. Search engine 940 includes a search engine that enables users of application system 930 to input and execute search queries to retrieve information from one or more sources of information, such as user connection network 936, entity graph 932, knowledge graph 934, one or more data stores of data storage system 960, or one or more data resources and tools 950.

In the example of FIG. 9, application system 930 includes a content distribution service 938. The content distribution service 938 includes a data storage service, such as a web server, which stores digital content items, and transmits digital content items to users via user interface 912. In some examples, content distribution service 938 processes requests from, for example, application system 930 and/or agent system 980, and distributes digital content items to user systems 910 in response to requests.

A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, an input of a search query, or a page load. In some examples, content distribution service 938 is part of application system 930. In other examples, content distribution service 938 interfaces with application system 930 and/or agent system 980, for example, via one or more application programming interfaces (APIs).

In the example of FIG. 9, application system 930 includes a search engine 940. Search engine 940 includes a software system designed to search for and retrieve information by executing queries on one or more data stores, such as databases, connection networks, and/or graphs. The queries are designed to find information that matches specified criteria, such as keywords and phrases contained in user input and/or system-generated queries. For example, search engine 940 is used to retrieve data in response to user input and/or system-generated queries, by executing queries on various data stores of data storage system 960 and/or data resources and tools 950, or by traversing entity graph 932, knowledge graph 934.

Data resources and tools 950 include computing resources, such as data stores, databases, embedding-based retrieval mechanisms, code generators, etc., that are capable of being used to operate an agent or agent system. Data resources and tools 950 include computing resources that are internal to application system 930 or external to application system 930. Examples of data resources and tools 950 include entity graphs, knowledge graphs, indexes, databases, networks, applications, models (e.g., large language models and/or other artificial intelligence models or machine learning models), taxonomies, data services, web pages, vectors (e.g., data stores that store embeddings), and searchable digital catalogs. Each data resource or tool 950 enables an agent or agent system to access the data resource or tool, for example by providing an application programming interface (API). Each data resource or tool 950 includes a monitoring service that periodically generates, publishes, or broadcasts availability and/or other performance metrics associated with the data resource, in some examples. A data resource or tool 950 provides a set of APIs that are used by an agent or agent system to access the data resource or tool, obtain output from the data resource, and/or obtain performance metrics for the data resource or tool, in some examples.

Data storage system 960 includes data stores and/or data services that store digital data received, used, manipulated, and produced by application system 930 and/or agent system 980, including contextual data, state data, prompts and/or prompt templates for generative artificial intelligence models or large language models, user inputs, system-generated outputs, metadata, attribute data, activity data. Databases or data stores that are capable of being used in some of the described examples include but are not limited to vector databases, graph databases, relational databases, and key-value stores.

In the example of FIG. 9, data storage system 960 includes various data stores that store, for example, entity data, context data, prompts, embeddings, etc. A data store includes include a volatile memory such as a form of random access memory (RAM) and/or persistent memory, which can be available on user system 910 or another device (e.g., one or more servers) for storing state data generated at the user system 910 or an application system 930. In some examples, a separate, personalized version of each or any data store is created for each user such that data is not shared between or among the separate, personalized versions of the data stores.

In some examples, data storage system 960 includes multiple different types of data storage and/or a distributed data service. In some examples, data service refers to a physical, geographic grouping of machines, a logical grouping of machines, or a single machine. In some examples, a data service includes a data center, a cluster, a group of clusters, or a machine. Data stores of data storage system 960 are capable of storing data produced by real-time and/or offline (e.g., batch) data processing. A data store configured for real-time data processing is referred to as a real-time data store, in some examples. A data store configured for offline or batch data processing is referred to as an offline data store, in some examples. Data stores are capable of being implemented using databases, such as key-value stores, relational databases, and/or graph databases. Data is written to and read from data stores using query technologies, e.g., SQL or NoSQL.

Data storage system 960 resides on one or more persistent and/or volatile storage devices that reside within the same local network as other devices of computing system 900 and/or in a network that is remote relative to other devices of computing system 900. Thus, although depicted as being included in computing system 900, portions of data storage system 960 are part of computing system 900 or accessed by computing system 900 over a network, such as network 920, in some examples.

Event logging service 970 captures and records activity data generated during operation of application system 930 and/or agent system 980, including user interface events generated at user systems 910 via user interface 912, in real time, and formulates the user interface events and/or other network activity data into a data stream that is consumed by, for example, a stream processing system. Examples of network activity data include logins, page loads, dialog inputs, input of search queries or query terms, selections of facets or filters, clicks on search results or graphical user interface control elements, scrolling lists of search results, and social action data such as likes, shares, comments, and social reactions (e.g., “insightful,” “curious,” “like,” etc.). For instance, when a user of application system 930 via a user system 910 enters input or clicks on a user interface element, such as a workflow element, or a user interface control element such as a view, comment, share, or reaction button, or uploads a file, or inputs a query, or scrolls through a feed, etc., event logging service 970 fires an event to capture and store log data including an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web applications and mobile applications.

For instance, when a user enters input or reacts to system-generated output, such as a list of search results, event logging service 970 stores the corresponding event data in a log. Event logging service 970 generates a data stream that includes a record of real-time event data for each user interface event that has occurred. Event data logged by event logging service 970 is pre-processed and anonymized as needed so that it is capable of being used as context data to, for example, configure one or more instructions for one or more artificial intelligence models (e.g., large language models), or to modify weights, affinity scores, or similarity measurements that are assigned by the agent system to search results or data resources.

Agent system 980 includes any one or more of the components, features, or functions described herein with respect to a multi-agent system. For example, agent system 980 includes components of distributed system 104, automated agent 802, and/or distributed multi-agent system 805.

AI model service 990 includes one or more artificial intelligence-based models, such as large language models and/or other types of machine learning models including discriminative and/or generative models, neural networks, probabilistic models, statistical models, transformer-based models, and/or any combination of any of the foregoing. AI model service 990 enables automated agents and agent systems to access to these models, for example by providing one or more application programming interfaces (APIs). AI model service 990 includes a monitoring service that periodically generates, publishes, or broadcasts latency and/or other performance metrics associated with the models. In some examples, AI model service 990 provides a set of APIs that are used by an agent or agent system to obtain performance metrics for large language models and/or other machine learning models.

While not specifically shown, it should be understood that any of user system 910, application system 930, data resources and tools 950, data storage system 960, event logging service 970, agent system 980, and AI model service 990 includes an interface embodied as computer programming code stored in computer memory that when executed causes a computing device to enable bidirectional communication with any other of user system 910, application system 930, data resources and tools 950, data storage system 960, event logging service 970, agent system 980, and AI model service 990 using a communicative coupling mechanism. Examples of communicative coupling mechanisms include network interfaces, inter-process communication (IPC) interfaces and application program interfaces (APIs).

Each of user system 910, application system 930, data resources and tools 950, data storage system 960, event logging service 970, agent system 980, and AI model service 990 is implemented using one or more computing devices that are communicatively coupled to electronic communications network 920. Any of user system 910, application system 930, data resources and tools 950, data storage system 960, event logging service 970, agent system 980, and AI model service 990 are capable of being bidirectionally communicatively coupled by network 920. User system 910 as well as other different user systems (not shown) are bidirectionally communicatively coupled to application system 930 and/or agent system 980, in some examples.

Examples of users of user system 910 include an administrator or end user of application system 930 or agent system 980. User system 910 is configured to communicate bidirectionally with any of application system 930, data resources and tools 950, data storage system 960, event logging service 970, agent system 980, and AI model service 990 over network 920.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 910, application system 930, data resources and tools 950, data storage system 960, event logging service 970, agent system 980, and AI model service 990 are implemented using computer software, hardware, or software and hardware, and include combinations of automated functionality, data structures, and digital data, which are represented schematically in the figures. User system 910, application system 930, data resources and tools 950, data storage system 960, event logging service 970, agent system 980, and AI model service 990 are shown as separate elements in FIG. 9 for case of discussion but, except as otherwise described, the illustration is not meant to imply that separation of these elements is required. The illustrated systems, services, and data stores (or their functionality) of each of user system 910, application system 930, data resources and tools 950, data storage system 960, event logging service 970, agent system 980, and AI model service 990 are capable of being divided over any number of physical systems, including a single physical computer system, and are capable of communicating with each other in any appropriate manner.

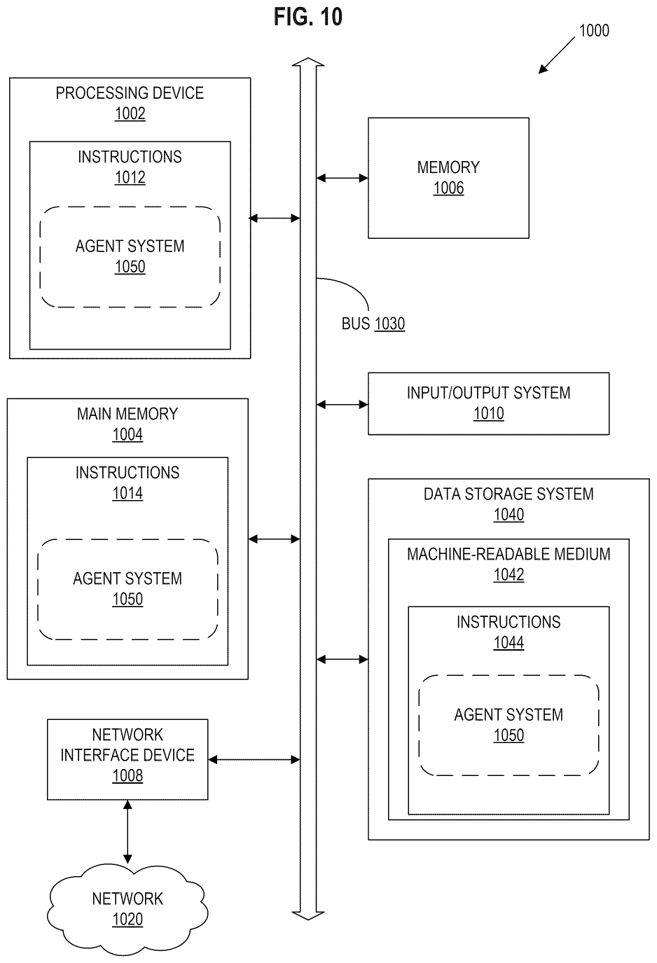

In the example of FIG. 10, portions of agent system 980 that are capable of being implemented on a front end system, such as one or more user systems, and portions of agent system 980 that are capable of being implemented on a back end system such as one or more servers, are collectively represented as agent system 1050 for case of discussion only. In some examples, portions of agent system 980 are not required to be implemented all on the same computing device, in the same memory, or loaded into the same memory at the same time. In some examples, access to portions of agent system 980 is limited to different, mutually exclusive sets of user systems and/or servers. In some examples, a separate, personalized version of agent system 980 is created for each user of the agent system 980 such that data is not shared between or among the separate, personalized versions of the agent system 980. Certain portions of agent system 980 are capable of being implemented on user systems while other portions of agent system 980 are capable of being implemented on a server computer or group of servers. In some examples, one or more portions of agent system 980 are implemented on user systems. Agent system 980 is entirely implemented on user systems, e.g., client devices, in some examples. In some examples, a version of agent system 980 is embedded in a client device's operating system or stored at the client device and loaded into memory at execution time.

The examples shown in FIG. 9 and the accompanying description, above are provided for illustration purposes. This disclosure is not limited to the described examples.

FIG. 10 is a block diagram of an example computer system including components of an agent system in accordance with some examples of the present disclosure.

In FIG. 10, an example machine of a computer system 1000 is shown, within which a set of instructions for causing the machine to perform any of the methodologies discussed herein are capable of being executed. In some examples, the computer system 1000 corresponds to a component of a networked computer system (e.g., any one or more of the components shown in FIG. 1, FIG. 3, FIG. 4, FIG. 6, FIG. 8, or FIG. 9) that includes, is coupled to, or utilizes a machine to execute an operating system to perform operations corresponding to any one or more components shown in FIG. 1, FIG. 3, FIG. 4, FIG. 6, FIG. 8, or FIG. 9. For example, computer system 1000 corresponds to a portion of a computing system when the computing system is executing a portion of any one or more components shown in FIG. 1, FIG. 3, FIG. 4, FIG. 6, FIG. 8, or FIG. 9.

The machine is connected (e.g., networked) to other machines in a network, such as a local area network (LAN), an intranet, an extranet, and/or the Internet. The machine operates in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a memory 1003 (e.g., flash memory, static random access memory (SRAM), etc.), an input/output system 1010, and a data storage system 1040, which communicate with each other via a bus 1030.

Processing device 1002 represents one or more general-purpose processing devices such as a microprocessor, a central processing unit, or the like. In some examples, the processing device is a complex instruction set computing (CISC) microprocessor, reduced instruction set computing (RISC) microprocessor, very long instruction word (VLIW) microprocessor, or a processor implementing other instruction sets, or processors implementing a combination of instruction sets. In some examples, processing device 1002 includes a special-purpose processing device such as an application specific integrated circuit (ASIC), a field programmable gate array (FPGA), a digital signal processor (DSP), network processor, or the like. The processing device 1002 is to execute instructions 1012 for performing the operations and steps discussed herein.

In some examples of FIG. 10, agent system 1050 represents portions of automated agent 802 or distributed multi-agent system 805 or agent system 980 while the computer system 1000 is executing those portions of automated agent 802 or distributed multi-agent system 805 or agent system 980. Instructions 1012 include portions of agent system 1050 when those portions of the agent system 1050 are being executed by processing device 1002. Thus, the agent system 1050 is shown in dashed lines as part of instructions 1012 to illustrate that, at times, portions of the agent system 1050 are executed by processing device 1002. For example, when at least some portion of the agent system 1050 is embodied in instructions to cause processing device 1002 to perform the method(s) described herein, some of those instructions are read into processing device 1002 (e.g., into an internal cache or other memory) from main memory 1004 and/or data storage system 1040. In some examples, it is not required that all of the agent system 1050 be included in instructions 1012 at the same time and portions of the agent system 1050 are stored in another component of computer system 1000 at other times, e.g., when a portion of the agent system 1050 is not being executed by processing device 1002.

The computer system 1000 further includes a network interface device 1008 to communicate over the network 1020. Network interface device 1008 provides a two-way data communication coupling to a network. In some examples, network interface device 1008 includes an integrated-services digital network (ISDN) card, cable modem, satellite modem, or a modem to provide a data communication connection to a corresponding type of telephone line. In some examples, network interface device 1008 includes a local area network (LAN) card to provide a data communication connection to a compatible LAN. Wireless links are included, in some examples. Network interface device 1008 sends and receives electrical, electromagnetic, or optical signals that carry digital data representing various types of information.

The network link is capable of providing data communication through one or more networks to other data devices. In some examples, a network link provides a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 1000.

Computer system 1000 is capable of sending messages and receiving data, including program code, through the network(s) and network interface device 1008. In some examples, a server is capable of transmitting a requested code for an application program through the Internet and network interface device 1008. The received code is executed by processing device 1002 as it is received, and/or stored in data storage system 1040 or other non-volatile storage for later execution.

The input/output system 1010 includes an output device, such as a display, for example a liquid crystal display (LCD) or a touchscreen display, for displaying information to a computer user, or a speaker, a haptic device, or another form of output device. The input/output system 1010 includes an input device, for example, alphanumeric keys and other keys configured for communicating information and command selections to processing device 1002. An input device sometimes includes a cursor control, such as a mouse, a trackball, or cursor direction keys for communicating direction information and command selections to processing device 1002 and for controlling cursor movement on a display. An input device sometimes includes a microphone, a sensor, or an array of sensors, for communicating sensed information to processing device 1002. Examples of sensed information include voice commands, audio signals, geographic location information, haptic information, and/or digital imagery, for example.

The data storage system 1040 includes a machine-readable storage medium 1042 (also known as a computer-readable medium) on which is stored instructions 1044 or software embodying any of the methodologies or functions described herein. The instructions 1044 sometimes reside, completely or at least partially, within the main memory 1004 and/or within the processing device 1002 during execution thereof by the computer system 1000, the main memory 1004 and the processing device 1002 also constituting machine-readable storage media. In one example, the instructions 1044 include instructions to implement functionality corresponding to an automated agent or agent system (e.g., any one or more of the components shown in any one or more components shown in FIG. 1, FIG. 3, FIG. 4, FIG. 6, and/or portions of computing system 800 of FIG. 8 or agent system 980 of FIG. 9).

Dashed lines are used in FIG. 10 to indicate that it is not required that the agent system be embodied entirely in instructions 1012, 1014, and 1044 at the same time. In one example, portions of the agent system are embodied in instructions 1014, which are read into main memory 1004 as instructions 1014, and portions of instructions 1012 are read into processing device 1002 as instructions 1012 for execution. In another example, some portions of the agent system are embodied in instructions 1044 while other portions are embodied in instructions 1014 and still other portions are embodied in instructions 1012.

While the machine-readable storage medium 1042 is shown in an example to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media.

The examples shown in FIG. 10 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure refers to actions and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations described herein. This apparatus is specially constructed for the intended purposes, in some examples. In other examples, the apparatus includes a general-purpose computer selectively activated or reconfigured by a computer program stored in the computer. In some examples, a computer system or other data processing system including any one or more of the components shown in FIG. 1, FIG. 2, FIG. 3, FIG. 4, FIG. 5, FIG. 6, FIG. 7, and/or FIG. 8, carries out the above-described computer-implemented methods in response to its processor executing a computer program (e.g., a sequence of instructions) contained in a memory or other non-transitory machine-readable storage medium. Such a computer program is be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems are capable of being used. A more specialized apparatus is constructed, in some examples. Examples of structure for these systems are provided in the description. Aspects of this disclosure are not limited to any particular programming language. A variety of programming languages are usable to implement the various aspects of this disclosure.

Some examples of the present disclosure are provided as a computer program product, or software, which includes a machine-readable medium having stored thereon instructions, which is used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein are capable of being implemented with privacy safeguards to protect user privacy. Furthermore, the techniques described herein are capable of being implemented with user privacy safeguards to prevent unauthorized access to personal data and confidential data. The training of the AI models described herein is executed to benefit all users fairly, without causing or amplifying unfair bias.

According to some examples, the techniques for the models described herein do not make inferences or predictions about individuals unless requested to do so through an input. According to some examples, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users are capable of having full control over the visibility of their content and who sees their content, as is controlled via the visibility settings. According to the techniques described herein, users are capable of having full control over the level of their personal data that is shared and distributed between different AI platforms that provide different functionalities.

According to the techniques described herein, users are capable of choosing to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users are capable of having full control over the level of access to their personal data that is shared with other parties. According to the techniques described herein, personal data provided by users is capable of being processed to determine prompts when using a generative AI feature at the request of the user, but not to train generative AI models. In some examples, users are capable of providing feedback while using the techniques described herein, which is capable of being used to improve or modify the platform and products. In some examples, any personal data associated with a user, such as personal information provided by the user to the platform, is deleted from storage upon user request. In some examples, personal information associated with a user is permanently deleted from storage when a user deletes their account from the platform.

According to the techniques described herein, personal data is capable of being removed from any training dataset that is used to train AI models. In some examples, the techniques described herein utilize tools for anonymizing member and customer data. A user's personal data is capable of being redacted and minimized in training datasets for training AI models through delexicalization tools and other privacy enhancing tools for safeguarding user data. The techniques described herein are capable of minimizing use of any personal data in training AI models, including removing and replacing personal data. In examples of the techniques described herein, notices are communicated to users to inform how their data is being used and users are provided controls to opt-out from their data being used for training AI models.

According to some examples, tools are used with the techniques described herein to identify and mitigate risks associated with AI in all products and AI systems. In some examples, notices are provided to users when AI tools are being used to provide features.

Illustrative examples of the technologies disclosed herein are provided below. An example of the technologies includes any of the examples described herein, or any combination of any of the examples described herein, or any combination of any portions of the examples described herein.

In some aspects, the techniques described herein relate to a method including: providing a multi-agent system including a managing agent, task agents, skill agents, and a registry distributed across components of a computer network; receiving a task at the managing agent, wherein the task is received from a device via a messaging platform of the computer network; at the managing agent, via a first lookup of the registry, determining a task agent to perform the task; at the managing agent, sending a task invocation to the task agent via the messaging platform, wherein the task invocation is to cause the task agent to initiate the task; at the managing agent, receiving a skill from the task agent, wherein the skill is a sub-task of the task; at the managing agent, via a second lookup of the registry, determining whether invoking a skill agent to perform the skill is to include using the messaging platform to maintain a thread; at the managing agent, responsive to determining that invoking the skill agent to perform the skill is not to include using the messaging platform to maintain a thread, including an identifier for the task agent in a call to the skill agent, wherein the call is to invoke the skill agent to perform the skill asynchronously to the task initiated by the task agent; at the managing agent, receiving the identifier for the task agent from the skill agent in response to the call; at the managing agent, causing the task agent to provide a response to the task to the device via the messaging platform, wherein the response includes output of the skill performed by the skill agent asynchronously to the task initiated by the task agent.

In some aspects, the techniques described herein relate to a method, system, apparatus, or non-transitory computer readable medium comprising any combination of any of the aspects shown or described anywhere in this disclosure, including in any of (i) the preceding aspects, (ii) the specification, (iii) the drawings, or (iv) any combination of (i), (ii), (iii).

Clause 1. A method comprising: providing a multi-agent system comprising a managing agent, task agents, skill agents, and a registry distributed across components of a computer network; receiving a task at the managing agent, wherein the task is received from a device via a messaging platform of the computer network; at the managing agent, via a first lookup of the registry, determining a task agent to perform the task; at the managing agent, sending a task invocation to the task agent via the messaging platform, wherein the task invocation is to cause the task agent to initiate the task; at the managing agent, receiving a skill from the task agent, wherein the skill is a sub-task of the task; at the managing agent, via a second lookup of the registry, determining whether invoking a skill agent to perform the skill is to include using the messaging platform to maintain a thread; at the managing agent, responsive to determining that invoking the skill agent to perform the skill is not to include using the messaging platform to maintain a thread, including an identifier for the task agent in a call to the skill agent, wherein the call is to invoke the skill agent to perform the skill asynchronously to the task initiated by the task agent; at the managing agent, receiving the identifier for the task agent from the skill agent in response to the call; at the managing agent, causing the task agent to provide a response to the task to the device via the messaging platform, wherein the response comprises output of the skill performed by the skill agent asynchronously to the task initiated by the task agent.

Clause 2. A method, system, apparatus, or non-transitory computer readable medium comprising any combination of any of the aspects shown or described anywhere in this disclosure, including in any of (i) the preceding clauses, (ii) the specification, (iii) the drawings, or (iv) any combination of (i), (ii), (iii).

Aspects of the disclosure have been described with reference to specific examples thereof. Various modifications are capable of being made to the described examples without departing from the spirit and scope of the disclosure reflected in the claims. The specification and drawings are illustrative and not restrictive.

What is claimed is:

1. A method comprising:
providing a multi-agent system comprising a managing agent, task agents, skill agents, and a registry distributed across components of a computer network;
receiving a task at the managing agent, wherein the task is received from a device via a messaging platform of the computer network;
at the managing agent, via a first lookup of the registry, determining a task agent to perform the task;
at the managing agent, sending a task invocation to the task agent via the messaging platform, wherein the task invocation is to cause the task agent to initiate the task;
at the managing agent, receiving a skill from the task agent, wherein the skill is a sub-task of the task;
at the managing agent, via a second lookup of the registry, determining whether invoking a skill agent to perform the skill is to include using the messaging platform to maintain a thread;
at the managing agent, responsive to determining that invoking the skill agent to perform the skill is not to include using the messaging platform to maintain a thread, including an identifier for the task agent in a call to the skill agent, wherein the call is to invoke the skill agent to perform the skill asynchronously to the task initiated by the task agent;
at the managing agent, receiving the identifier for the task agent from the skill agent in response to the call; and
at the managing agent, causing the task agent to provide a response to the task to the device via the messaging platform, wherein the response comprises output of the skill performed by the skill agent asynchronously to the task initiated by the task agent.

2. The method of claim 1, wherein a task comprises at least one of query execution, content generation, or computer code generation to control a device.

3. The method of claim 1, further comprising: at the managing agent, responsive to determining that invoking the skill agent to perform the skill is to include using the messaging platform to maintain the thread, invoking the sub-task synchronously, creating the thread, and using the thread to track status of skill invocations.

4. The method of claim 1, further comprising:
determining that an execution time for the skill does not exceed a threshold latency;
invoking the skill agent asynchronously; and
using the messaging platform to track the execution time of the skill.

5. The method of claim 1, further comprising:
determining that an execution time for the skill exceeds a threshold latency; and
invoking the skill agent asynchronously using a return call to the managing agent.

6. The method of claim 1, further comprising:
at the skill agent, invoking a plurality of skills asynchronously.

7. The method of claim 1, wherein the skill comprises a call to a generative machine learning model (GMLM).

8. The method of claim 1, further comprising routing all skills associated with the task to a first distributed component of the computer network.

9. The method of claim 8, further comprising shifting the skill from the first distributed component to a second distributed component of the computer network different from the first distributed component in accordance with at least one of a traffic shifting policy or a load balancing policy.

10. The method of claim 1, further comprising routing at least two skills associated with the task to at least two distributed components of the computer network.

11. The method of claim 10, further comprising storing state information relating to the task and the skill in a memory that is accessible by the at least two distributed components of the computer network.

12. A system comprising:
a processor; and
a memory comprising instructions that when executed cause the processor to:
provide a multi-agent system comprising a managing agent, task agents, skill agents, and a registry distributed across components of a computer network;
receive a task at the managing agent, wherein the task is received from a device via a messaging platform of the computer network;
at the managing agent, via a first lookup of the registry, determine a task agent to perform the task;
at the managing agent, send a task invocation to the task agent via the messaging platform, wherein the task invocation is to cause the task agent to initiate the task;
at the managing agent, receive a skill from the task agent, wherein the skill is a sub-task of the task;
at the managing agent, via a second lookup of the registry, determine whether invoking a skill agent to perform the skill is to include using the messaging platform to maintain a thread;
at the managing agent, responsive to determining that invoking the skill agent to perform the skill is not to include using the messaging platform to maintain a thread, include an identifier for the task agent in a call to the skill agent, wherein the call is to invoke the skill agent to perform the skill asynchronously to the task initiated by the task agent;
at the managing agent, receive the identifier for the task agent from the skill agent in response to the call; and
at the managing agent, cause the task agent to provide a response to the task to the device via the messaging platform, wherein the response comprises output of the skill performed by the skill agent asynchronously to the task initiated by the task agent.

13. The system of claim 12, wherein a task comprises at least one of query execution, content generation, or computer code generation to control a device.

14. The system of claim 12, wherein the instructions further cause the processor to: at the managing agent, responsive to determining that invoking the skill agent to perform the skill is to include using the messaging platform to maintain the thread, invoke the sub-task synchronously, creating the thread, and using the thread to track status of skill invocations.

15. The system of claim 12, wherein the instructions further cause the processor to:
determine that an execution time for the skill does not exceed a threshold latency;
invoke the skill agent asynchronously; and
use the messaging platform to track the execution time of the skill.

16. The system of claim 12, wherein the instructions further cause the processor to:
determine that an execution time for the skill exceeds a threshold latency; and
invoke the skill agent asynchronously using a return call to the managing agent.

17. A non-transitory machine readable storage media comprising instructions that when executed cause a processor to:
provide a multi-agent system comprising a managing agent, task agents, skill agents, and a registry distributed across components of a computer network;
receive a task at the managing agent, wherein the task is received from a device via a messaging platform of the computer network;
at the managing agent, via a first lookup of the registry, determine a task agent to perform the task;
at the managing agent, send a task invocation to the task agent via the messaging platform, wherein the task invocation is to cause the task agent to initiate the task;
at the managing agent, receive a skill from the task agent, wherein the skill is a sub-task of the task;
at the managing agent, via a second lookup of the registry, determine whether invoking a skill agent to perform the skill is to include using the messaging platform to maintain a thread;
at the managing agent, responsive to determining that invoking the skill agent to perform the skill is not to include using the messaging platform to maintain a thread, include an identifier for the task agent in a call to the skill agent, wherein the call is to invoke the skill agent to perform the skill asynchronously to the task initiated by the task agent;
at the managing agent, receive the identifier for the task agent from the skill agent in response to the call; and
at the managing agent, cause the task agent to provide a response to the task to the device via the messaging platform, wherein the response comprises output of the skill performed by the skill agent asynchronously to the task initiated by the task agent.

18. The non-transitory machine readable storage media of claim 17, wherein the instructions further cause the processor to shift the skill from the first distributed component to a second distributed component of the computer network different from the first distributed component in accordance with at least one of a traffic shifting policy or a load balancing policy.

19. The non-transitory machine readable storage media of claim 17, wherein the instructions further cause the processor to route at least two skills associated with the task to at least two distributed components of the computer network.

20. The non-transitory machine readable storage media of claim 19, wherein the instructions further cause the processor to store state information relating to the task and the skill in a memory that is accessible by the at least two distributed components of the computer network.
